(19) United States
(12) Patent Application Publication
(10) Pub. No.: US 2007/0203756 A1
(43) Pub. Date: Aug. 30, 2007

(54) Configuration of employee benefit plans

(75) Inventors: Todd Allen Sears, San Mateo, CA (US); Ann Katherine Klein, Oakland, CA (US); Hong Qian, Union City, CA (US); Hang Lu, Foster City, CA (US)

Correspondence Address: CSA LLP, 4807 SPICEWOOD SPRINGS RD., BLDG. 4, SUITE 201, AUSTIN, TX, 78759, US

(73) Assignee: Siebel Systems, Inc.

(21) Appl. No.: 10/322,381

(22) Filed: Dec. 17, 2002

Related U.S. Application Data
(60) Provisional application No. 60/341,625, filed on Dec. 17, 2001.

(51) Int. Cl. G06Q 40/00; G06F 15/18

(52) U.S. Cl. 705/4; 706/8

(57) ABSTRACT

A method, system, and computer program product to create a quote for providing a benefit, such as an employee benefit of a group health insurance policy or a retirement plan. Products that can be associated with the quote are automatically determined using at least one rule for associating products with quotes. A product can be associated with the quote if the product satisfies the rules. Rules can require another product to be included with the product in the quote, require a given value for an attribute of the product, or require a relationship between the values of attributes of different products. Rules can also be added to specify how data for the products are presented in a display via a user interface. A user can use a configuration user interface to set up rules.

### CROSS-REFERENCE TO RELATED APPLICATION

This application claims the benefit of priority based on U.S. Provisional Patent Application Ser. No. 60/341,625, entitled “Method And Apparatus For Configuring Employee Benefits” filed Dec. 17, 2001, and naming Todd Allen Sears, Ann Katherine Klein, Hong Qian, and Hang Lu as the inventors. The above-referenced application is hereby incorporated by reference herein in its entirety.

### BACKGROUND OF THE INVENTION

1. Field of the Invention

This invention relates to defining, generating, and managing customized employee benefit plans for individuals and groups of individuals.

2. Description of the Related Art

Health care insurance is an example of a customized service plan with complex relationships and rules that affect pricing and service provisioning. Other insurance services such as policies related to life, home, auto, and disability are also based on complex relationships and rules. Multiple services and related industries including investment management, commodities and stock brokerages, financial management services such as those related to banking, and legal services provide uniquely tailored services that depend on a number of static and dynamic factors and considerations.

In providing such services, proposals are sent, quotes returned, and specific terms of the policy are managed. A service provider such as an insurer must ensure that quotes are cost-effective and meet the needs of clients and members of the clients, with consideration to a multitude of pre-existing and changing factors and/or set of rules affecting each proposal.

Companies or employers are considered as a distribution channel for employee benefits such as health care insurance. Employers are also a major distribution channel for lines of insurance such as life and disability insurance. In health care, a great percentage of individuals covered by insurance receive insurance through employee insurance plans. As such, the term ‘employee benefits’ is used herein to include such benefits as group insurance policies.

Typically, in the example of insurance services, an employer with a given number of employees may request an insurance broker to find insurance policies to cover its employees. In many instances, the group of employees can be divided into subgroups that require different services or have different rates for similar services. An insurance broker, in turn, seeks out coverage plans based on the information that is provided by the employer and obtains quotes from insurance providers through a request for quotes (RFQs).

Insurance companies can manage several segments of group insurance. The segments can be grouped as shown in Table 1:

TABLE 1

| Group | Number of Individuals |
|---|---|
| Small groups | 2-100 or 200 |
| Medium groups | 100 or 200 to 500 |
| Large groups | 500 to 5,000 |
| National Account groups | 5,000 and greater |

The large group and national account group segments are often difficult to manage due to the number of individuals covered and the variance of coverage for the individuals involved. To cover such large groups, detailed contracts are drawn between the insured customer (employer) and insurance companies. The insurance plan is typically customized, necessitating a complex contract with thousands of features and clauses to cover all the requirements of the individuals in the particular insurance group. Smaller insurance group segments, typically associated with small business employers or people seeking individual insurance coverage, can also include a degree of flexibility in plan design and rates.

Insurance companies (insurers) face added complexity in developing quotations for all segments of groups due to what is, in effect, a double sales process. Such a double sales process includes the sale of the contract (group policy) having the proposed plan and design to the employer (the first sale), and the subsequent sale to the employees to be covered (who choose a particular insurer's coverage from a number of insurers' coverage in an employee benefits package).

When employee benefit plan designs are created, information related to specific plan designs must be made available to personnel that require such information. Personnel can include client representatives (who answer client questions regarding coverage), claims adjusters (who provide payment for insurance claims), and certain administrative personnel of the insurer.

A goal of insurers is to simplify the group insurance sales process. However, plans are negotiated according to specific clauses and features inherent in each plan design. In other words, selling and providing a plan design is complicated by the requirements that will be unique to each plan design.

To complicate matters, group insurance distribution channels are part of a complex system that includes insurer consultants, independent agents and brokers, and insurer employees. Insurer employees that are part of the channels of insurance distribution include general agents, group account managers, and telephone sales representatives. The world wide web (WWW) and Internet are also distribution channels for insurance. Often, allowing potential members to access and select coverage through the WWW and via the Internet is convenient and desirable.

Simplifying the sales and provision of employee benefits (e.g., insurance) is desirable; however, the complexity of the sales process that includes tailoring a quote to fulfill specific requirements and needs limits the ability to simplify. In certain cases, service providers (such as insurance companies) have created software to manage individual and unique accounts; however, software written for the service provider is often tailored for the service provider's specific needs and is not easily adapted for user by other organizations.

### SUMMARY OF THE INVENTION

The present invention provides a method, system, and computer program product to create a quote for providing a benefit, such as an employee benefit of a group health insurance policy or a retirement plan. Products that can be associated with the quote are automatically determined using at least one rule for associating products with quotes. A product can be associated with the quote if the product satisfies the rules.

Rules can require another product to be included with the product in the quote, require a given value for an attribute of the product, or require a relationship between the values of attributes of different products. Rules can also be added to specify how data for the products are presented in a display via a user interface. A user can use a configuration user interface to set up rules.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a flow chart illustrating the processes of creating a policy or product, creating a quote, and identifying eligible members.

FIG. 2 is an entity relationship diagram illustrating relationships between objects that determine products and/or services.

FIG. 3 is an entity relationship diagram illustrating the interrelationship of objects in creating a product or service plan.

FIG. 4 is a flow chart illustrating a process for associating products with product classes.

FIG. 5 is a flow chart that describes a process for associating products with configuration models.

FIG. 6 is a diagram of an interface for adding a new product class of products and/or services.

FIG. 7 is a diagram of an interface for adding a new product.

FIG. 8 is a diagram of an interface for setting coverage levels for products.

FIG. 9 is a diagram of an interface for setting rate bands for products.

FIG. 10 is a diagram of an interface showing versions of a configuration model for the product.

FIG. 11 provides an example of a configuration rule relating one product to another.

FIG. 12 is a diagram of an interface for selecting a configuration rule from a set of configuration rules.

FIG. 13 is a diagram of an interface for configuring display properties for a product.

FIG. 14A is a diagram of an interface for setting up configuration rules.

FIG. 14B is another diagram of an interface for setting up configuration rules.

FIG. 15 is a diagram of an interface for establishing links to non-product information that can be used for generating configuration rules for a given product.

FIG. 16 is a flow chart for creating quotes and policies.

FIG. 17 is a flow chart for entering members (employees).

FIG. 18 is a diagram of an interface for creating a group policy quote.

FIG. 19 is a diagram of an interface for adding census records to quotes or policies.

FIG. 20 is a diagram of an interface for associating segmented census records with a quotation or policy.

FIG. 21 is a diagram of an interface for associating detailed census records with a quotation or policy.

FIG. 22 is a diagram of an interface showing employee classes and product classes associated with each employee class for a given quotation or policy.

FIG. 23 is a diagram of an interface displaying a plan or quotation, including proposed products and their attributes.

FIG. 24 is a diagram of an interface showing employee classes associated with a given policy in a particular policy or quote.

FIG. 25 is a diagram of an interface showing an alternative representation of employee class and product intersection.

FIG. 26 is a diagram of an interface showing rates for product and employee class intersection.

FIG. 27 is a diagram of an interface showing a quote proposed for a group policy.

FIG. 28 is a diagram of an interface for adding eligible members.

FIG. 29 is a diagram of an interface for adding eligible members using a network such as the Internet.

FIG. 30 is a diagram of an interface for directly enrolling eligible members for a group policy.

FIG. 31 is a diagram of an interface for adding dependents and beneficiaries for an enrolled member.

FIG. 32 is a diagram of an interface for relating group policies to components such as activities.

FIG. 33 is a diagram of an interface for relating group policies to components such as notes.

FIG. 34 is a diagram of an interface for relating group policies to components such as service requests.

FIG. 35 is a diagram of an interface for relating group policies to components such as billing information.

FIG. 36 is a block diagram illustrating a network environment in which a system according to the present invention may be practiced.

FIG. 37 depicts a block diagram of a computer system suitable for implementing the present invention, and example of one or more of client computers.

FIG. 38 is a block diagram depicting a network in which the computer system is coupled to an internetwork, which is coupled, in turn, to client systems, as well as a server.

The use of the same reference symbols in different drawings indicates similar or identical items.

While the invention is susceptible to various modifications and alternative forms, specific embodiments thereof are shown as examples in the drawings and are described in detail. However, it should be understood that the drawings and detailed description are not intended to limit the invention to the particular form disclosed. On the contrary, the intention is to cover all modifications, equivalents, and alternatives falling within the scope of the present invention as defined by the appended claims.

### DETAILED DESCRIPTION

The following is intended to provide a detailed description of an example of the invention and should not be taken to be limiting of the invention itself. Rather, any number of variations may fall within the scope of the invention which is defined in the claims following the description.

Introduction

The present invention provides a method, system, and computer program product to create a quote for providing a benefit, such as an employee benefit of a group health insurance policy or a retirement plan. Products that can be associated with the quote are automatically determined using at least one rule for associating products with quotes. A product can be associated with the quote if the product satisfies the rules.

Rules can require another product to be included with the product in the quote, require a given value for an attribute of the product, or require a relationship between the values of attributes of different products. Rules can also be added to specify how data for the products are presented in a display via a user interface. A user can use a configuration user interface to set up rules.

Another product can be automatically associated with the quote when a rule indicates that the two products are to be provided together. Attribute values that are required can be automatically set, and required relationships between attribute values can be enforced according to the rules.

A quote created using the present invention can be associated with census information for a set of employees. Rates for the product can be obtained from a rating engine using the census information. The product can be automatically priced at the rate in the quote, and the product price can be overridden manually as a user configures the quote. When the quote is accepted, data about the quote are converted into data about the corresponding benefit. The present invention also allows employees to be enrolled to receive the benefit.

Software modules and appropriate interfaces are provided that allow membership and census information to be received and compared to existing products and services that provide employee benefits. The software modules and interfaces allow interaction between parties seeking products and/or services and those providing products and/or services. The software modules and interfaces also maintain product and/or service information when members are enrolled for such services.

Policy Creation and Membership Definition

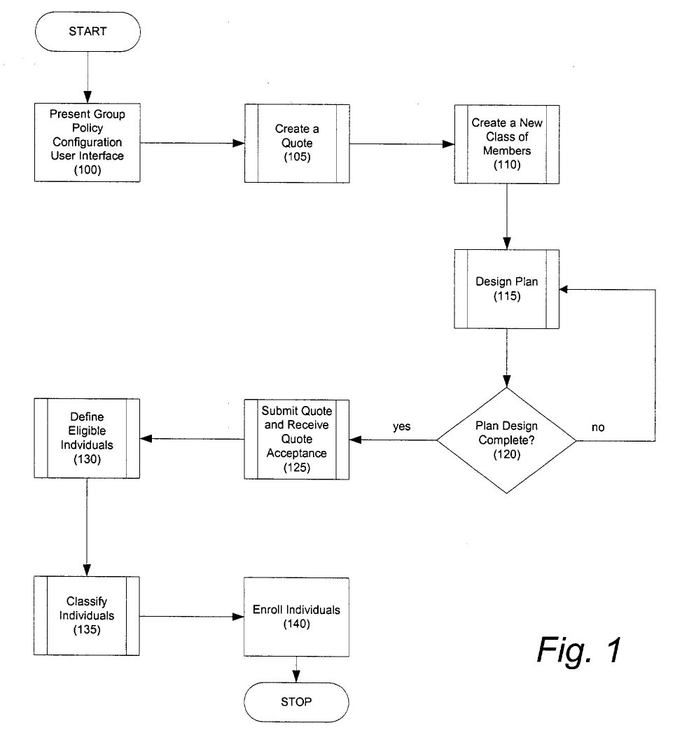

FIG. 1 is a flow chart illustrating the process of creating a policy or product, creating quotes, and defining eligible members. A predefined user interface is provided to an employer or party searching for benefits to create a policy, step 100. The terms ‘policy’ and ‘group policy’ are used herein as an example of an employee benefit for which a plan is to be developed and quoted. The processes described herein apply equally to other types of employee benefits, such as retirement plans.

Step 100 provides for an operational user interface that allows employers (parties) to provide relevant group information that affects policy or product plans. Information entered in step 100 can include the number of members of a particular group, pre-existing or current insurance coverage (e.g., Medicare, Cobra) relevant to the group, and comprehensive requirements required of the group. Step 100 provides for a user interface that interfaces to various databases and networks including the WWW and through the Internet.

Requests for quotations are sent out by an employer or broker for policy quotes from insurance companies, with the goal of finding the company or companies to provide the requested benefits. Creating a quote, step 105, involves taking into account specific needs and requirements of requesting employers (parties) and providing policy or product plans that meet those requirements. Typically, an agent or broker creates a quote to be submitted to the requesting employer or party. Step 105 allows for the identification of new opportunities or the potential to provide product plans to requesting employers or parties. Step 105 also provides an agent or broker to identify policy providers or companies that can provide coverage or product plans. In step 105, new group policies can be entered with information regarding quote status. Information provided for development of a quote can include the number of eligible members (employees), the number of employees (including ineligible employees, if any), the number of members, and the number of members having other coverage such as Medicare and/or Cobra.

One or more employee classes of members can be created, step 110. Employee class information can include particular employer divisions such as particular state locations for members (employees). Other information can include percentage contribution and dollar amounts to be spent on each member. Further census information for each member can be created. Census information can relate members to various classes; provide tier information (e.g., employee; family member; or dependent); indicate members having Medicare, Cobra, or other insurance coverage; and member health risk assessments (HRA).

Based on the requirements of the party seeking services or products, the current list of available services or products, and the possible variation of services or products, among other such criteria, a plan or policy is designed, step 115. Step 115 can include setting up product classes and product attributes, as well as rate bands, where a rate band covers the costs associated with various coverage plans for the group. In creating such a design, all pertinent product classes are associated for each product or plan offering. Customization for particular employer groups is possible, and a providing company (insurer) can configure sets of products or services that can be packaged together (where a group of products or services make up a plan) and identify attribute values that are available for each product or service. The resulting plan can include rate bands; deductible levels; and out-of-pocket payments (premiums). In designing the plan, new configuration attributes can be set that relate to the customized plan or policy. A determination is made whether the plan is complete, step 120. If the plan is not complete, step 115 continues. Once the plan is complete, the plan can be submitted as a quotation and accepted for purchase by the requesting the quotation party, step 125.

Eligible members are defined for the defined plan, step 130. Information from other databases, such as employee records, can be used in identifying eligibility of members. Products or services are identified by inclusion in the created plan, and the requisite attributes of members are identified that define eligibility to enroll to receive the particular products or services.

Individuals have certain attributes that can be used to place individuals into employee classes. Process 135 classifies individuals. Employee classes can include the following fields: coverage status; employer contribution percentage per employee; employer contribution per employee and spouse; employer contribution per employee, spouse, and dependent; predefined employer contribution; waiting period for eligibility; and employee standard industrial classification (SIC) code.

Members are enrolled to receive the appropriate products in the proposed plan, step 135. In step 135, census information related to members is examined. The individual census information is checked against an eligibility file. Individual members can be assigned to a particular employee class or classes. In one embodiment, members can enroll in services and plans themselves when choices are made available to members.

Entity Relationships

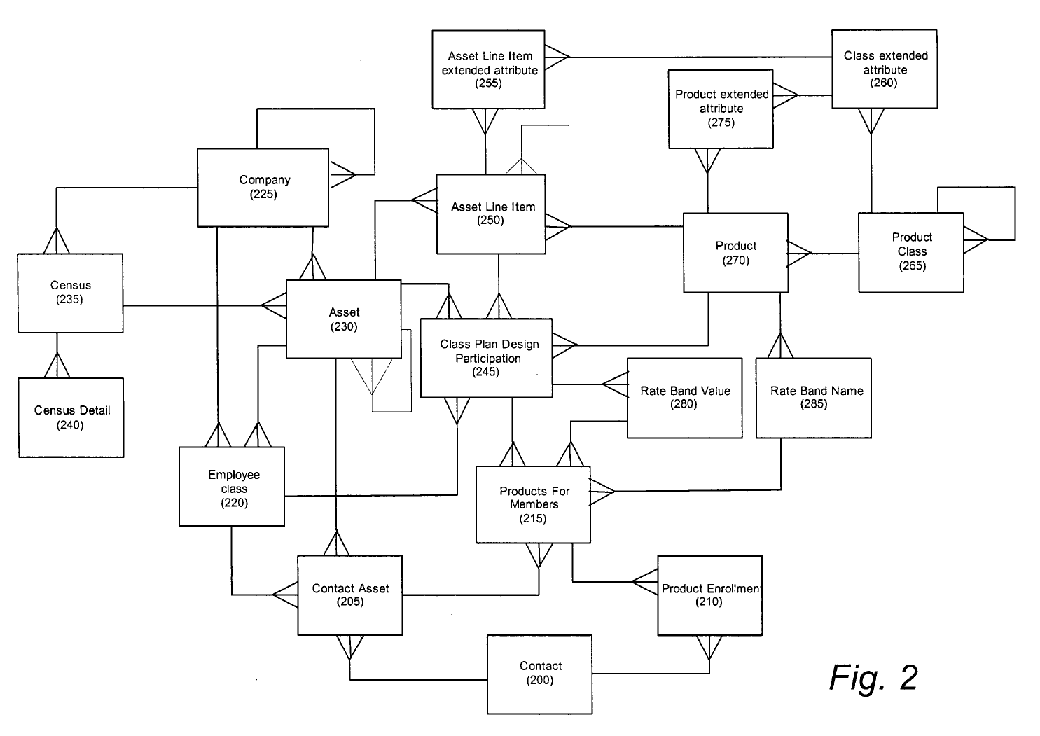

FIG. 2 is an entity relationship diagram illustrating the relationships between entities that determine products and/or services. Contact 200 represents an employer or a broker (a party that is seeking products and/or services). Contact 200 relates to multiple instances of contact asset 205, where a contact asset relates to an employer or a member covered by an employer. In this example, contact assets are instances of members or individuals for a particular insurance policy. Contact 200 also relates to multiple instances of product enrollment 210. Product enrollment 210 includes information related to membership enrollment in particular plans. Various products or plans are made available to members 215. For each plan or product for member 215, multiple instances of product enrollment 210 can exist. Multiple instances of plans or products relate to one instance of a member of a contact asset 205. Multiple instances of contact assets 205 also relate to a single class employee group 220, where employee class group 220 represents a group of members corresponding to a particular policy.

Multiple employee class groups 220 can be related to a single company 225. Multiple class groups can also relate to a single asset 230, where asset 230 is an available product or plan. Company 225 corresponds to an insurance company or a product or plan provider. In certain cases, a company can have another company provide the services on a subcontracting basis or according to another arrangement; therefore, a recursive relationship exists for company 225. Census information 235 related to individual members is provided to a company for purposes of responding to a request for quotation. Census information 235 can include a defined employee class to which each member belongs, a health risk assessment (HRA) of the individual, and various coverage plans to which the member is entitled. Census information 235 may be structured as one parent record with multiple census details 240, which are children records. A company 225 also has multiple available assets 230.

An asset 230 relates to one or more class plan design participation (CPDP) 245, where class plan design participation 245 represents a particular customized plan. One asset (product or plan) can be included within another asset, as illustrated by the asset 230 recursive relationship. A single CPDP 245 can be related to a number of products or services for members 215. Multiple instances of CPDP 245 can relate to a single asset line item 250, where at least one asset line item 250 makes up an asset 230.

Asset line item 250 can be described further by a number of extended attribute descriptions, as represented by asset line item extended attribute (ALIXA) 255. Multiple ALIXA 255 can relate to one product class extended attribute 260, i.e., a particular asset line attribute 255 can be related to a particular product class 265. Multiple product class extended attributes define a product class 265. Product class 265 has a recursive relationship, allowing a particular product class to include another product class. A recursive relationship allows for a more manageable relationship as opposed to the creation of new product classes each time one product includes another. Creating new product classes can lead to an expanding databases that require increased horizontal and vertical definitions; in other words, an expanding Cartesian (XY) table. A number of products 270 make up a product class 265. A product 270 is further defined by product extended attributes 275. Multiple product extended attributes 275 can also be related to a single product class extended attribute 260.

A rate band value 280 defines the pricing or rate range for services. Multiple rate band values 280 relate to a single CPDP 245 (a particular customized plan). Multiple products for members 215 relate to a single rate band value 280. A rate band name 285 can also be related to multiple products for members 215. Multiple rate band names 285 can be related to a single product 270.

Relationship in Creation of Plans

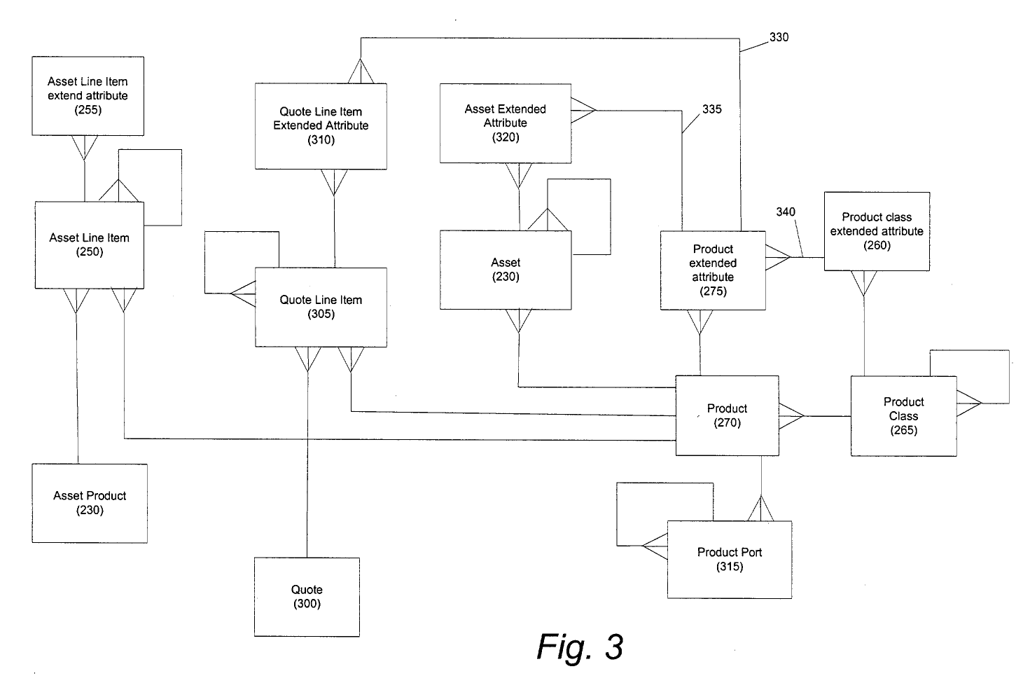

FIG. 3 is an entity relationship diagram illustrating relationships between entities in creating a product or service plan. A quote 300 is generated for services requested. Quote 300 relates to multiple quote line items 305, where quote line items 305 can include instances of other quote line items 305. A quote line item 305 can have multiple quote line item extended attributes 310.

Multiple quote line items 305 relate to a single product 270. A single product can also relate to multiple product ports 315. A product port 315 can have a recursive relationship, so that one product port instance can include another product port instance. An asset 230 can have several asset extended attributes 320. Multiple asset extended attributes 320 can also be related to a product extended attribute 275.

In this particular example, quote line item extended attribute 310 can have multiple relationships to a single product extended attribute 270. The relationship between quote line item extended attribute 310 and product extended attribute 275 is represented as relationship 330. More than one asset extended attribute 320 can be related to a single product extended attribute 275. The relationship between asset extended attribute 320 and product extended attribute 275 is labeled as relationship 335. More than one product extended attribute can be related to a single product class extended attribute 260. The relationship between product extended attribute 275 and product class extended attribute 260 is represented by relationship 340.

Associating Products with Classes and Configuration Models

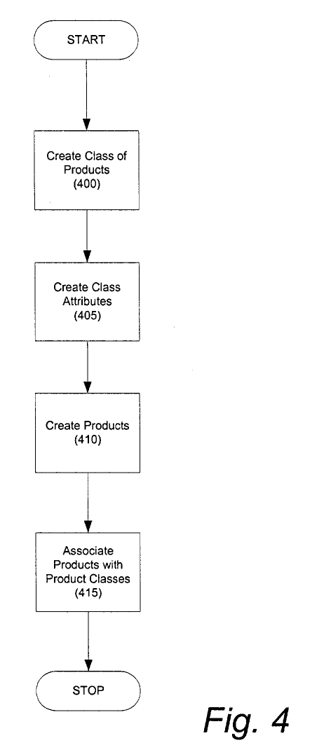

FIG. 4 is a flow chart for a process for associating products with product classes. Using the example of health care insurance, products or services are included in a comprehensive insurance plan. Products or services can have associated attributes such as coverage, premiums, and deductibles. Products or services can also be associated with product classes. A provider can provide or define product classes, step 400. Product classes are defined prior to placing products or services in the product classes.

Required attributes describe and define a product class. Product class attributes can be added as provided in step 405. Attributes of a particular product class define the products or services that can be associated with the product class or classes.

Products or services can exist prior to product class creation, or products and services can be created to fit an existing product class or classes. Accordingly, step 410 can be performed before step 400 or after step 405. Products or services can be associated with the defined product classes, step 415.

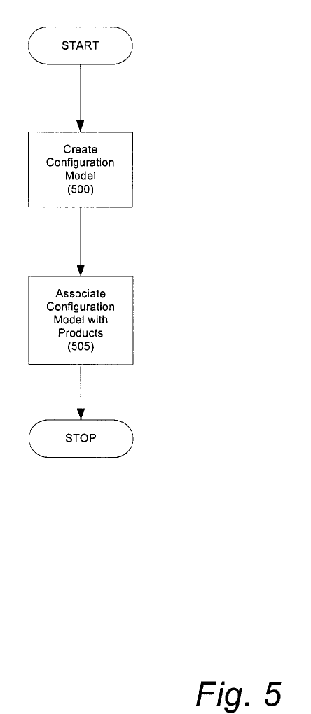

FIG. 5 is a flow chart that describes associating products with configuration models. A configuration model is used by a configuration module to present components of a policy or plan, such as products and eligible members, to be configured by a user. The configuration model specifies a layout for presenting the policy or plan to the user, identifies data that are to be presented together, and defines a user interface for viewing particular policy or plan components.

Configuration models can be customized to suit the needs of particular users, such as insurance providers, which create products and services, provide quotes to agents or brokers, and ultimately provide management information to members that are covered by the insurance provider's products or services. Once product or services are placed in product classes, configuration models with specific user interfaces can be created to view the products, step 500. Specific configuration models can be associated with specific products or services, step 505. Presentation of products or services can also be managed by (and configured in accordance with) a number of configuration models.

User Interfaces

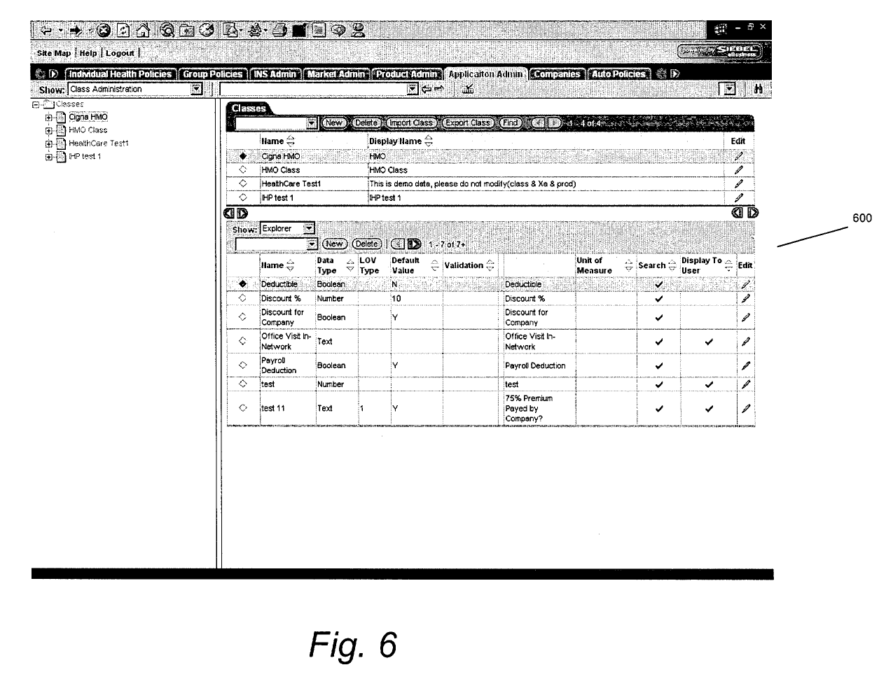

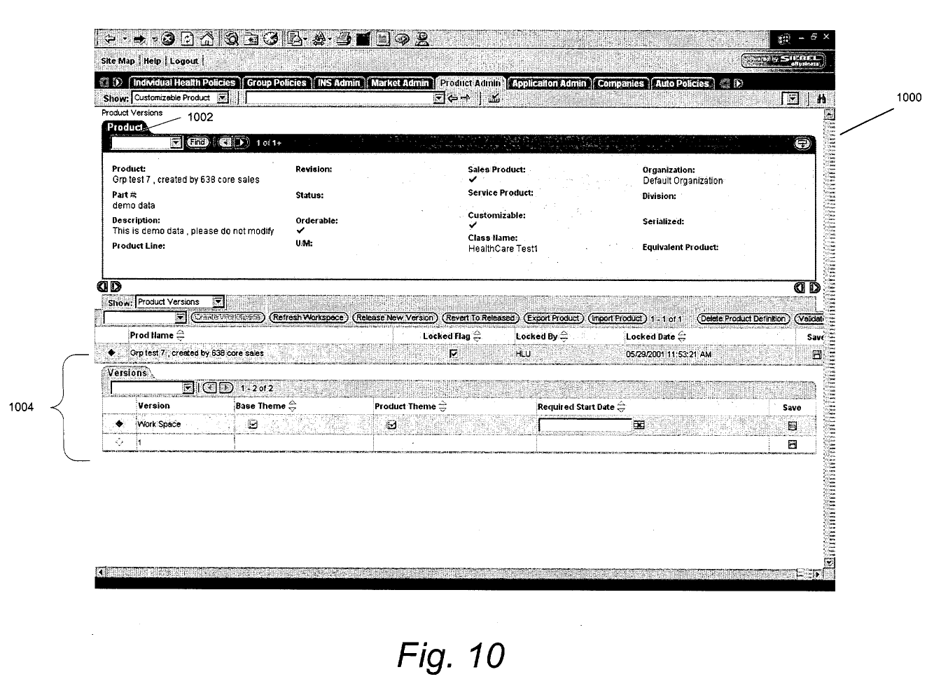

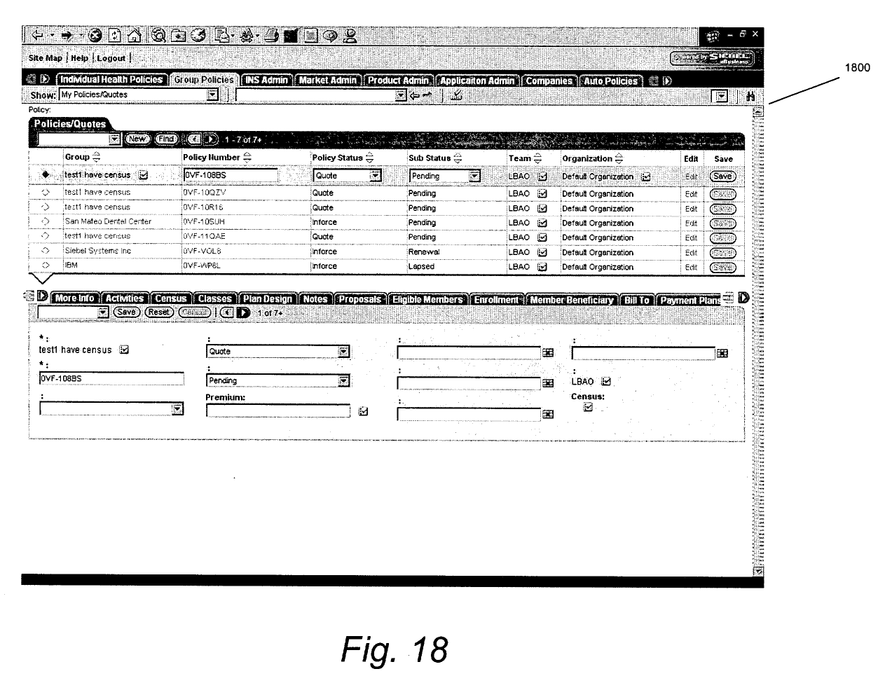

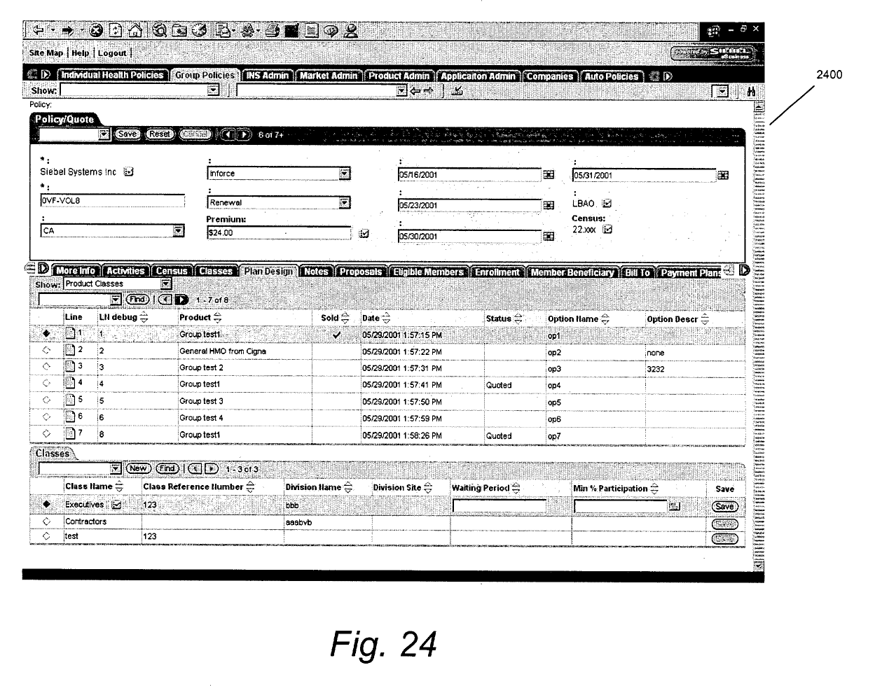

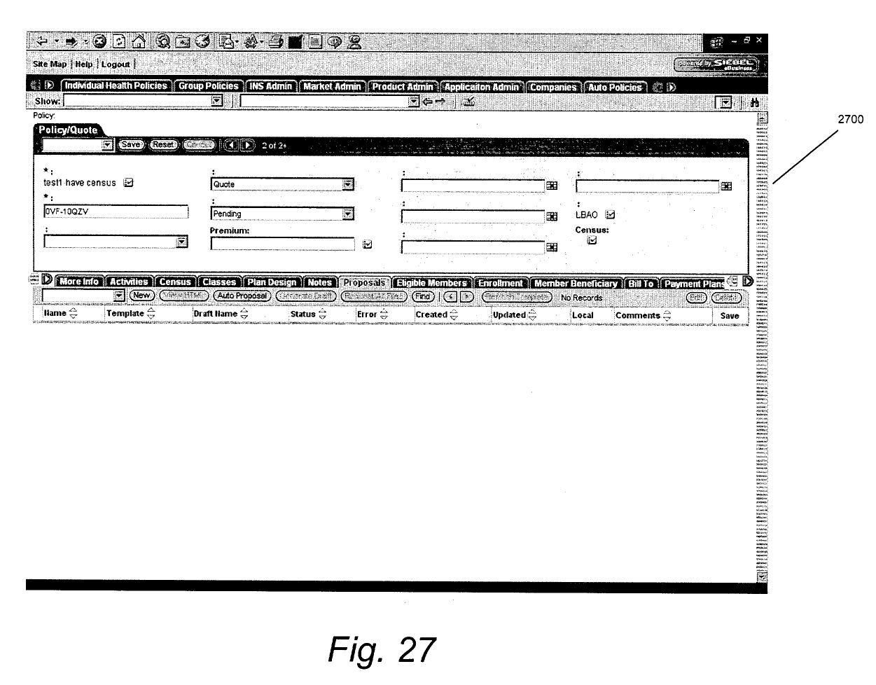

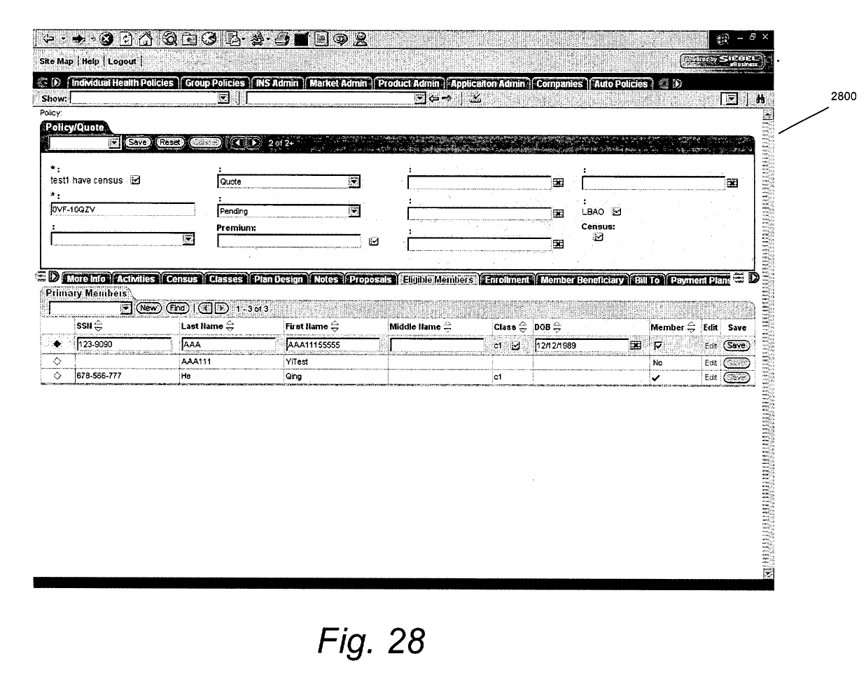

FIGS. 6 through 9 show interfaces for administration of products and services. FIGS. 10 through 15 show interfaces for configuring a user interface to create and maintain a group policy or quote, as well as options available to users during a configuration session. FIGS. 18 through 23 show interfaces for establishing and configuring a group policy or plan in response to a request for a quotation from a broker or employer. FIGS. 24 through 26 show interfaces for associating employee classes with products when configuring a group policy or quote. FIG. 27 shows an interface for configuring a quote. FIGS. 28 through 31 show interfaces for relating group policies to other data about a customer, such as activities, notes, service requests, and billing information.

FIGS. 6 through 9 show interfaces for administration of products and services. FIG. 6 is a diagram of an interface for adding a new product class of products and/or services. Interface 600 is a user interface for adding new product classes and set up parent product classes. Interface 600 can be used, for example, when adding new product classes as described with regard to step 265 of FIG. 2. Attributes can be added to each product class with default ranges and/or values. In this particular example, the class includes particular health care insurance services. Each product or service can have attributes such as deductibles, payroll deductions, and cost of an office visit within the network.

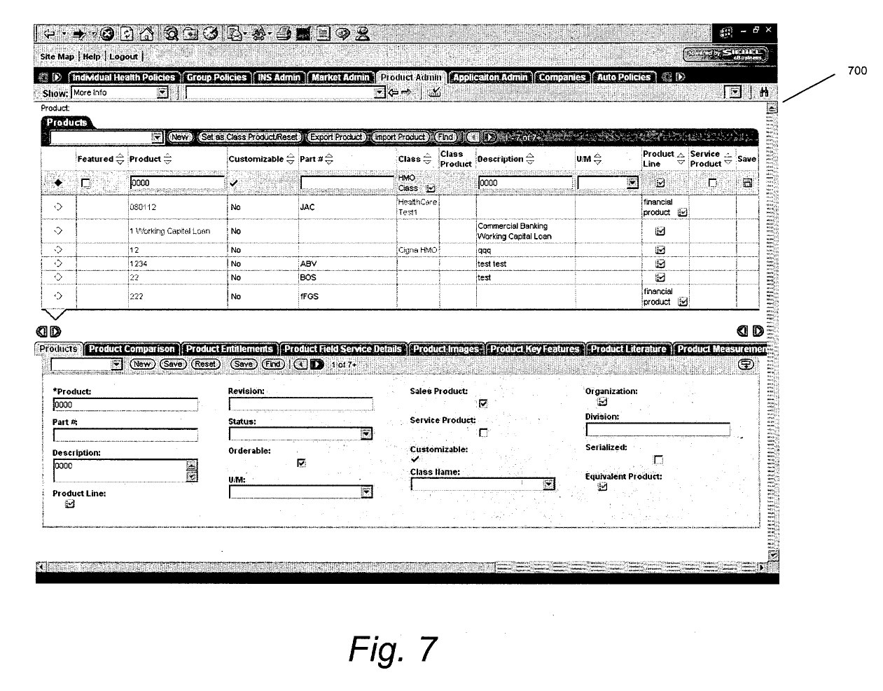

FIG. 7 is a diagram of an interface 700 for adding a new product. In certain cases, product or service attributes that are in conflict with product class attributes can be overridden. A product class can be identified for the new product when the new product is entered, thereby providing predefined attribute values that are specific to the product class. Products or services can also be associated with a product class using interface 700. Referring back to FIG. 2, interface 700 is an example of an interface that can be used to perform step 270, where a new product is added. Referring to FIG. 4, interface 700 can also be used in creating a new product.

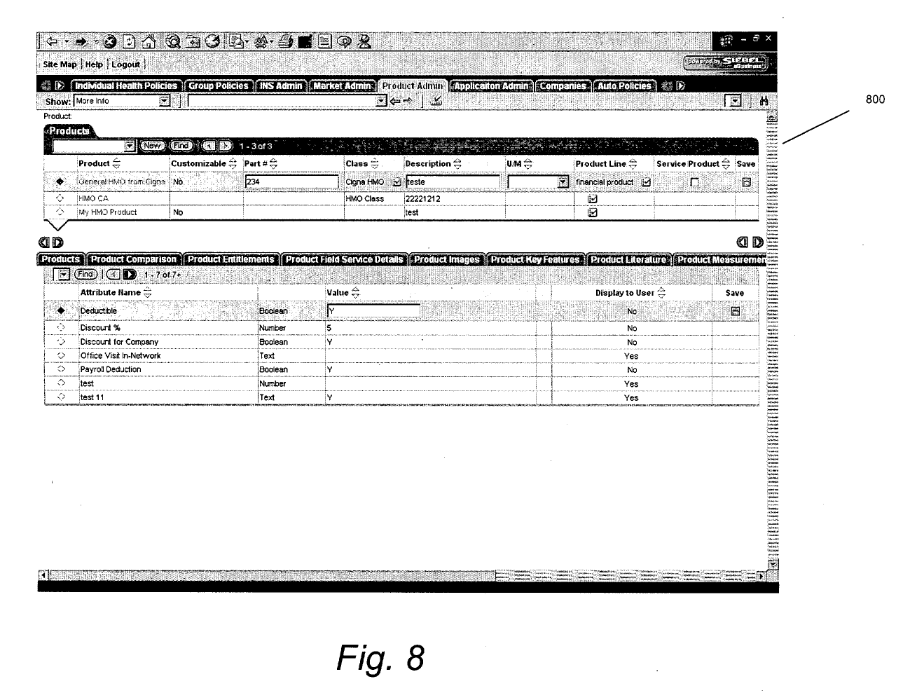

FIG. 8 is a diagram of an interface 800 for setting coverage levels for products. Coverage levels can include attributes related to payment, such as payroll deductibles, office deductibles, and employer's contribution. Interface 800 is used when products or services are established.

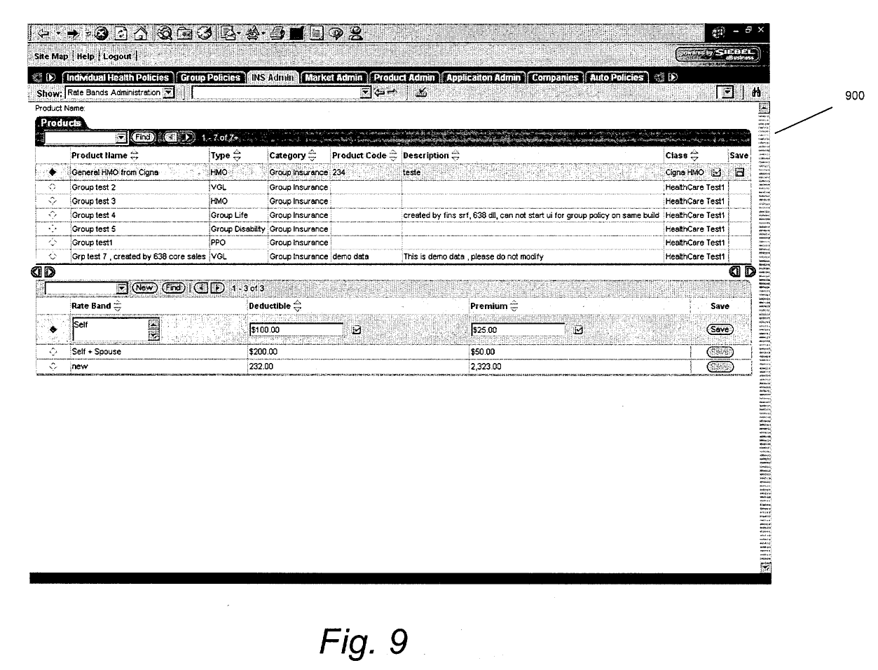

FIG. 9 is a diagram of an interface for setting rate bands for products. Interface 900 allows the user to set up rate bands covering deductibles to be met and premiums to be paid for each plan or product. Multiple levels for the rate bands can exist, and a preset premium can be added for a rate band. Several rate bands can be established for a product to cover certain cases, such as cases for employee, cases for employee and spouse, and other cases for which a different cost structure may be necessary. Referring back to FIG. 2, steps 280 and 285 illustrate setting up rate bands. Specifically, step 280 provides a rate band value, and step 285 provides a rate band name.

FIGS. 10 through 15 show interfaces for configuring rules defining a user interface for creating and maintaining a group policy or quote, as well as configuring attributes of entities and required and/or allowed relationships between entities. FIG. 10 is a diagram of an interface showing versions of a configuration model for the product. A configuration model for the product specifies rules and/or display properties for displaying the product in a user interface, as described previously with regard to FIG. 5. In the example shown, versions 1004 of the product shown in product tab 1002 are displayed.

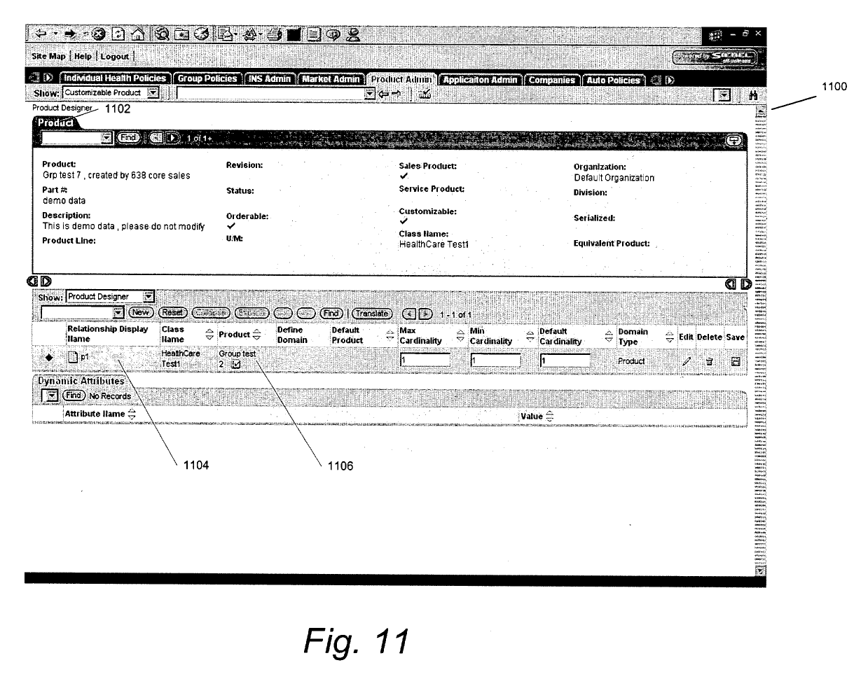

FIG. 11 provides an example of a configuration rule relating one product to another. This relationship indicates that, when the first product is displayed, the related product is also displayed. In this example, the product shown in product tab 1102 has a relationship (indicated by relationship display name 1104) to another product 1106, and the two products are displayed together.

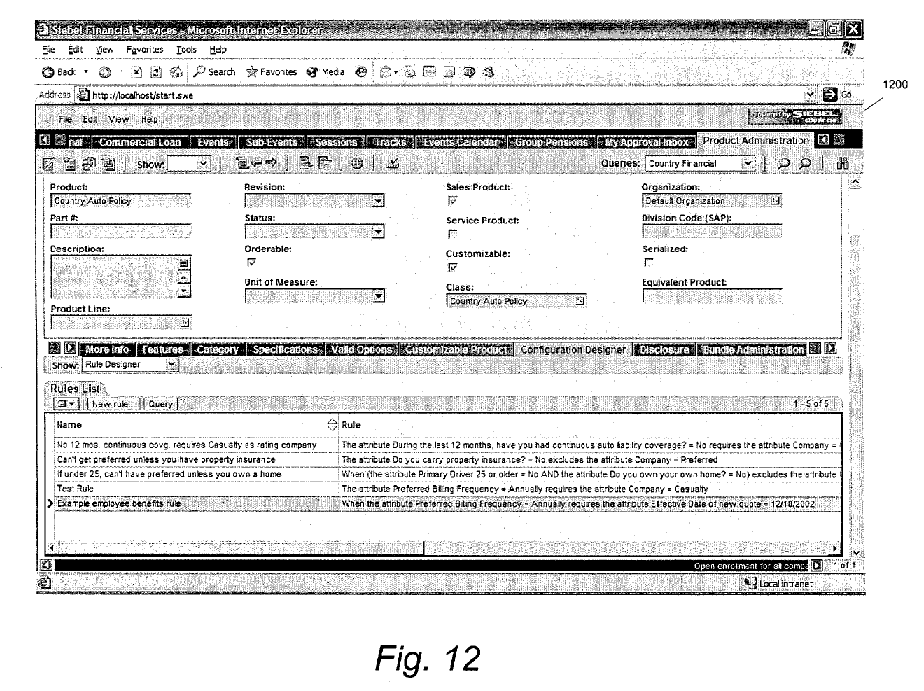

FIG. 12 is a diagram of an interface 1200 for selecting a configuration rule from a set of configuration rules. Configuration rules relate to required values of attributes and required or allowed relationships between attributes of entities. Configuration rules can specify relationships between attribute values of the same entity (e.g., product), relationships between attribute values for different entities (e.g., products), and other rules indicating whether a particular entity can be included in a design plan. Configuration rules are manifested in the presentation of data in a user interface for designing a policy or plan. For example, a rule requiring a particular attribute value can be manifested by disabling selection of another attribute value. A rule requiring relationship between attribute values of two different entities can be manifested by filling in one entity's attribute value when the other entity's attribute value is set. A rule requiring one entity to be included as part of another entity can be manifested by requiring values for both entities to be entered.

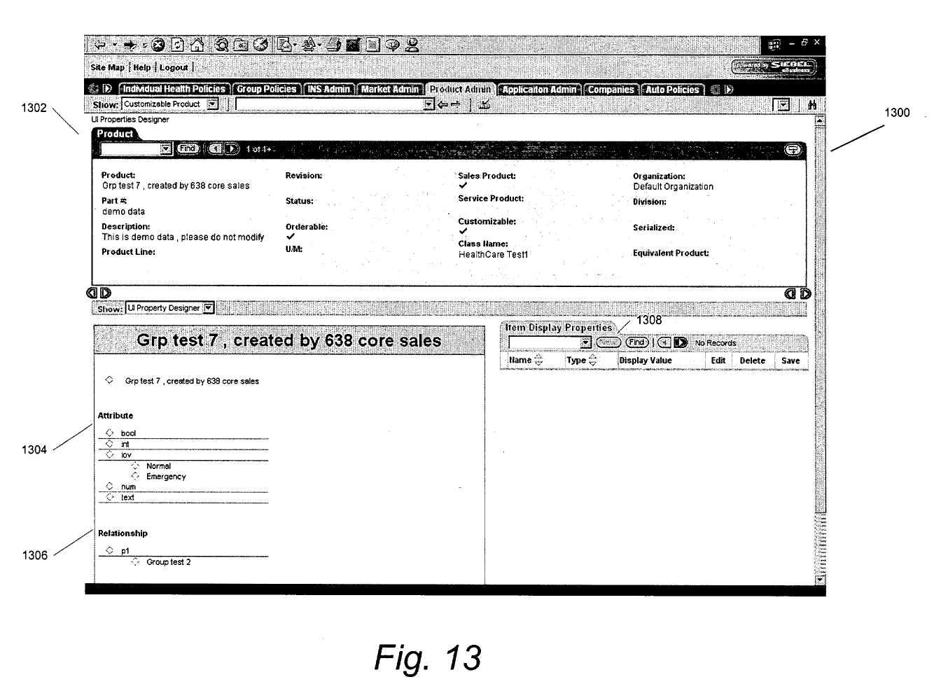

FIG. 13 is a diagram of an interface 1300 for configuring display properties for a product. In this example, the product shown in product tab 1302 is configured to be displayed with attributes and relationship 1306. Individual items to be displayed can be configured in item display properties tab 1308.

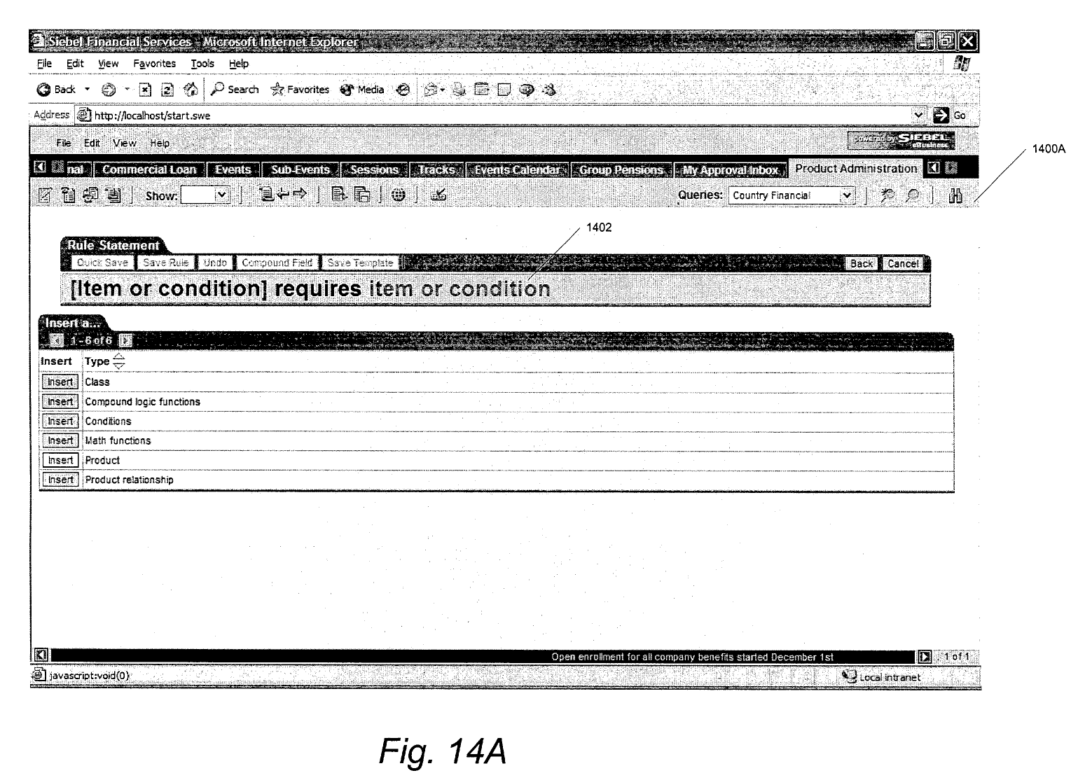

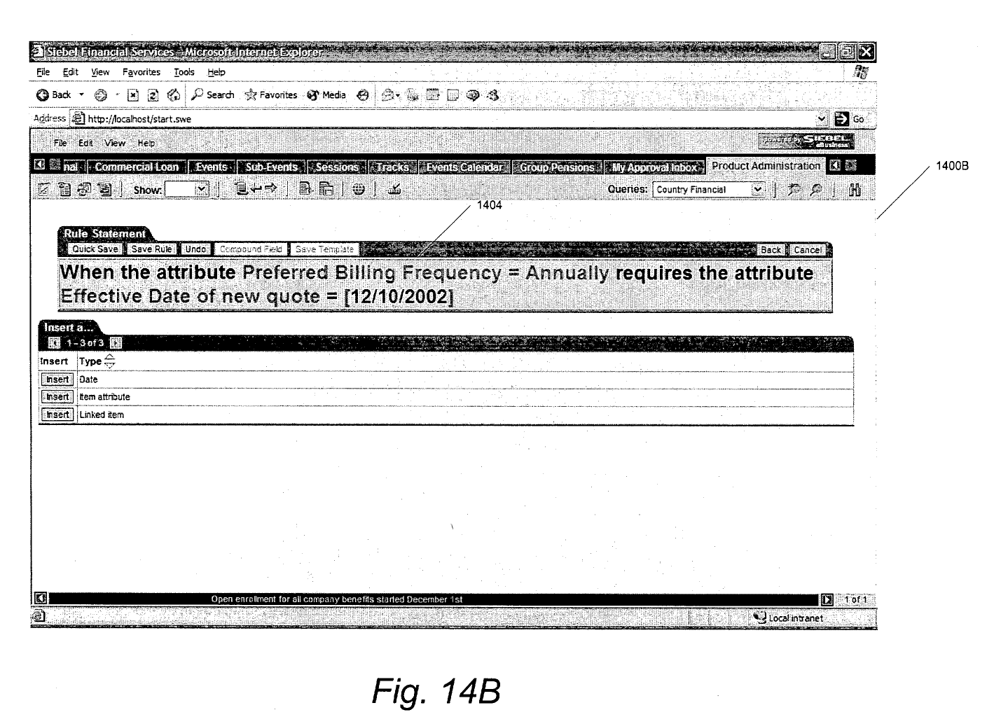

FIG. 14A is a diagram of an interface for setting up configuration rules. When a user interacts conducts a session using the configuration module, certain rules determine whether the user can view, enter, modify, or delete information. Rules can be established for particular products. Interface 1400A shows customization of a rule 1402 indicating that a given item or condition requires another item or condition. Referring back to FIG. 5, interface 1400A is an example of an interface used in setting up configuration models, step 500.

FIG. 14B is another diagram of an interface for setting up configuration rules. Interface 1400B shows customization of a rule 1404 for indicating that a given attribute values requires a particular value for another attribute.

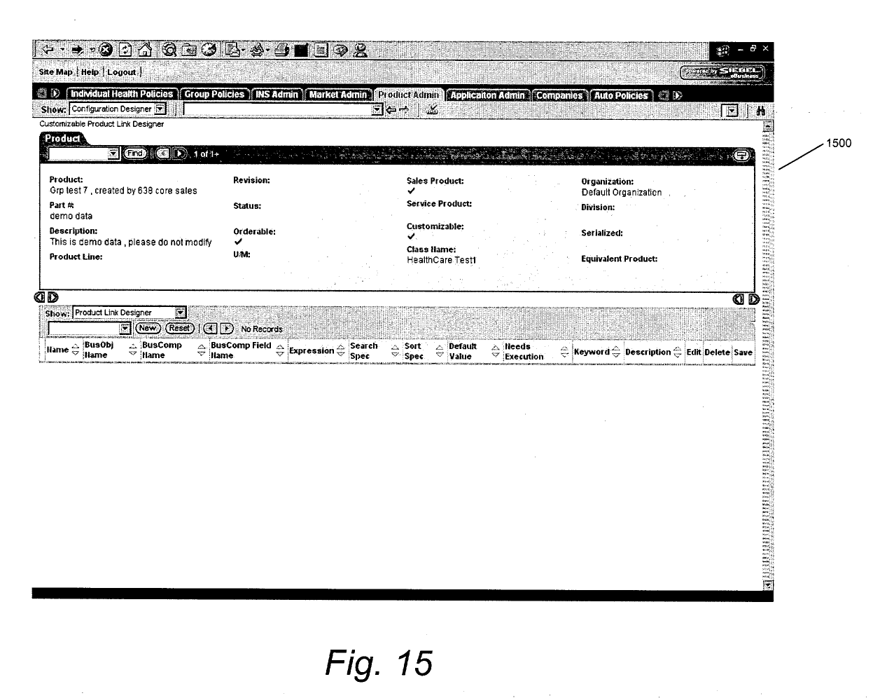

FIG. 15 is a diagram of an interface for establishing links to non-product information that can be used for generating configuration rules for a given product. In this particular example, interface 1500 allows a user to link this non-product information to a currently active configuration model for the product. A product record is selected, and other product record records can be associated with the current product record using a product link designer.

Quote and Policy Creation

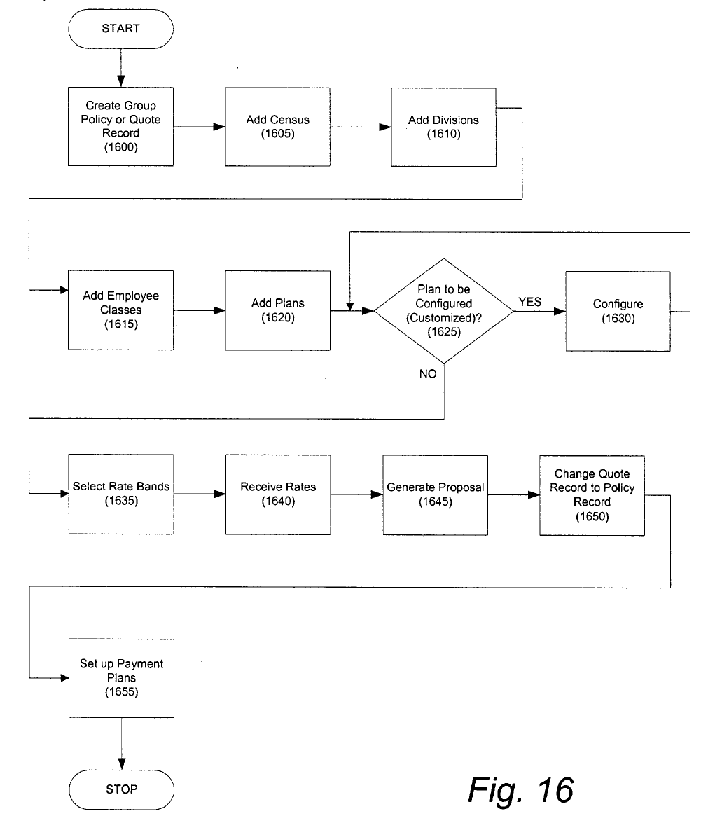

FIG. 16 is a flow chart for creating quotes and policies. Group policy or quote records are created in step 1600. A group policy or quote record can be created and maintained by a broker, agent; or, most commonly, an insurance provider. Group policy record information can later be provided to customers or employers after a quote is accepted and employees are ready for enrollment or enrolled. In one embodiment, a quote record can be converted to a group policy record in the same database by changing the status of the quote from “Quote” to “In Force.” Thus a reference to a single record as a group policy record or a quote record depends upon the point of time in the process of responding to a request for quotation.

Census information for individuals to be covered by the group policy can be provided as part of the request for quotation. Census information is added to group policy records, step 1605. Census information is an accumulation of all individual member census information. Census information relates to particular predefined attributes that are applicable to insurance coverage plans or services.

Members can be categorized into divisions, where divisions can be related to a physical location of specific members such as state or plant. Divisions can also be functional corporate divisions, such as engineering and manufacturing. Divisions are defined and added as necessary in step 1610.

Members can further be categorized into employee classes. Employee classes of members include salaried and hourly employees. Classification can also be based on health risk assessments (HRA), applicable coverage, and other member related attributes. Such employee classes are added in step 1615.

Plans based on the information of members is determined and are added, step 1620. Plans are created and defined, as discussed in further detail below. A single group policy or quote can have multiple plan designs. For example, a quote can be created for a group health insurance policy. Different plans can be established, such as a plan including an HMO product and another plan including an HMO Plus product. Depending upon differences in the product, different plans can have different features, providers, and/or premiums. An instance of an HMO or HMO Plus product record could be associated with a line item for a quote or a policy record.

A determination whether a plan should be configured to customize the plan for a specific request for quotation is made, step 1625. If the plan needs to be configured (i.e., customized), step 1630 follows. Plans are configured as discussed in further detail below.

After the plan is established and possibly customized, rate bands are selected for inclusion in the plan, step 1635. Rates can be received from a database or a rating engine, step 1640. Based on the information made available, a proposal to the requesting party is generated, step 1645. Different information can be tracked for different stages in the quoting and proposal process, such as whether the rate was manually adjusted, the bid rate, sold rate, final rate, final rate date, and payroll deduction amount.

The quote record can be converted to a policy record when the quote is accepted, step 1650. Payment plans can then be established, step 1655.

Entering Members

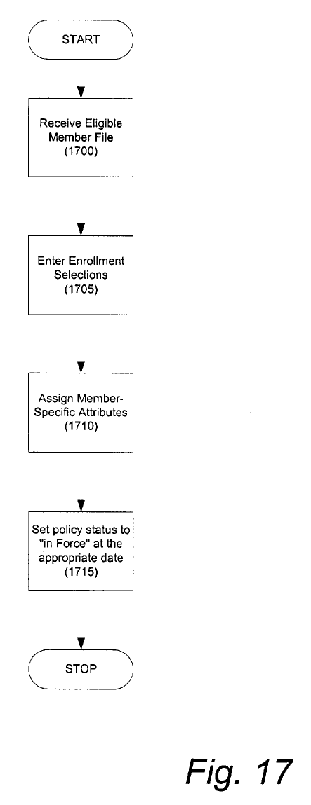

FIG. 17 is a flow chart for entering members (employees). A user can receive or create a file of eligible members, step 1700. Eligibility of membership is predetermined and eligible members are submitted for enrollment. Eligible members can have a number of product or service selections from which to choose. Members select coverage from available products or services and enroll for those products or services. Enrollment selections for employees are entered, step 1705. In enrollment for a product or service, a member may have the option or the requirement to define certain attributes. Examples of definable attributes are a designated primary care physician and beneficiaries. The individual member assigns values to these definable attributes, step 1710. After membership is entered, typical cases involve an effective date from which the member is actually eligible to use the product or service. An eligibility date is assigned to the individual by setting the policy status to “In Force” at the eligibility date, step 1715.

Interfaces to Quote and Policy Creation, and Member Enrollment

FIGS. 18 through 23 show interfaces for configuring a group policy or plan in response to a request for a quotation from a broker or employer. FIG. 18 is a diagram of an interface for creating a group policy quote. Interface 1800 allows group policy quote records to be converted to policy records when the quote is accepted. For example, the policy status can be changed from “Quote” to “In Force” when the quote is accepted. In this particular example, census data was considered for a particular group during development of the quote for providing the group policy. Group records are added or modified during the development of a quote or maintenance of a policy. Referring back to FIG. 3, interface 1800 can be used in receiving a quote, step 300, adding a quote line item, step 305, and adding a quote line item extended attribute, step 310.

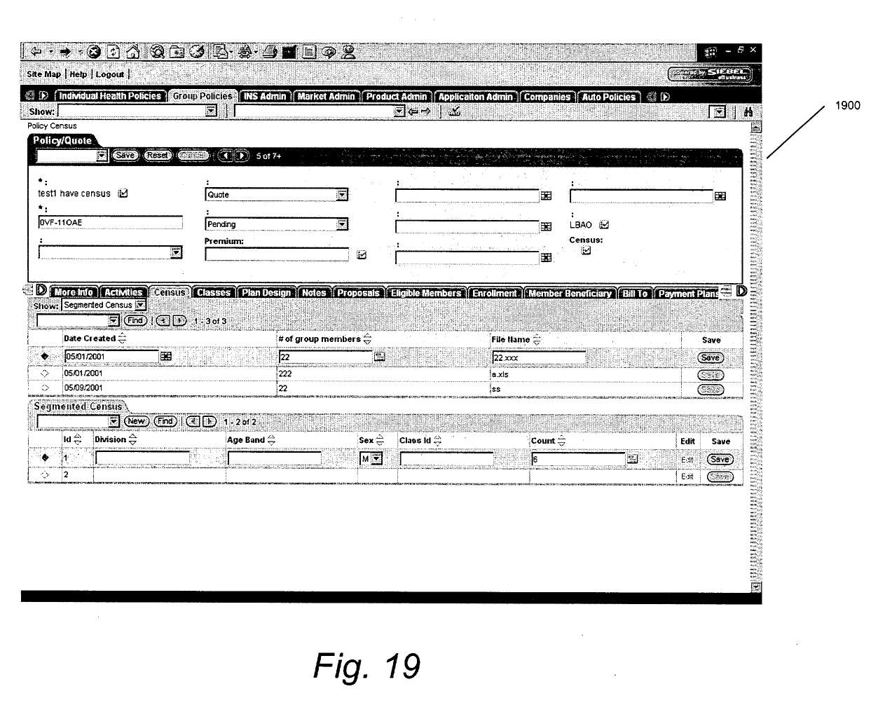

FIG. 19 is a diagram of an interface for adding census records to quotes or policies. Changes in census information affect pricing and quotes for policies; therefore, census records can be continually updated and modified to design a plan to fulfill the request for quotation. Census data can include segmented and detailed records. Referring back to FIG. 16, interface 1900 can be used to add census information, step 1605.

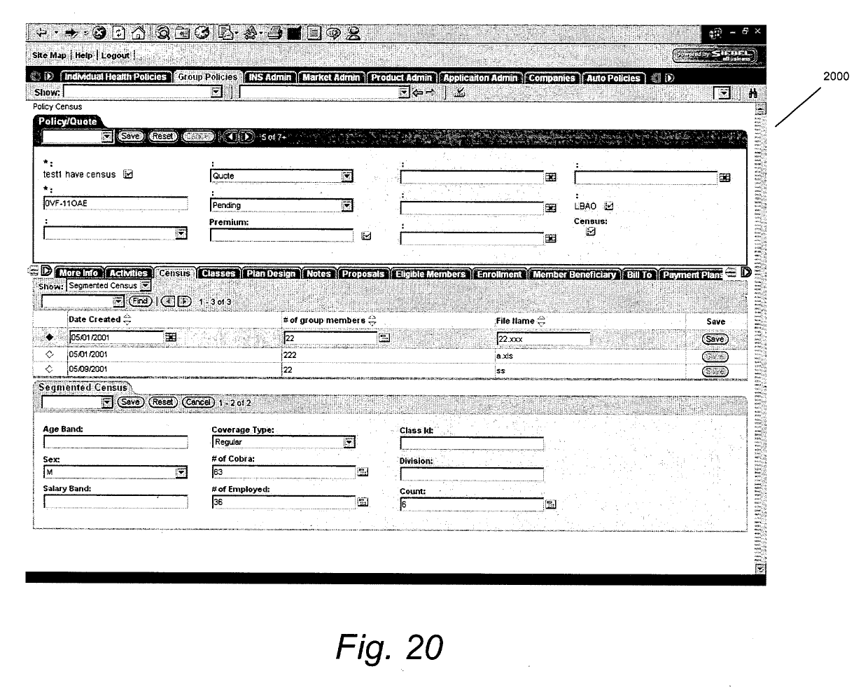

FIG. 20 is a diagram of an interface for associating segmented census records with a quotation or policy. Segmented census data involves a particular group or segment of members based on particular attributes or fields. Interface 2000 allows segmented census records to be entered. Interface 2000 includes segmented data fields “age band,” “sex,” “salary band,” “coverage type,” “# of Cobra,” “# of employed,” “class ID,” “Division,” and “count.” The number of members falling into each census segment affects pricing of the group policy or quotation.

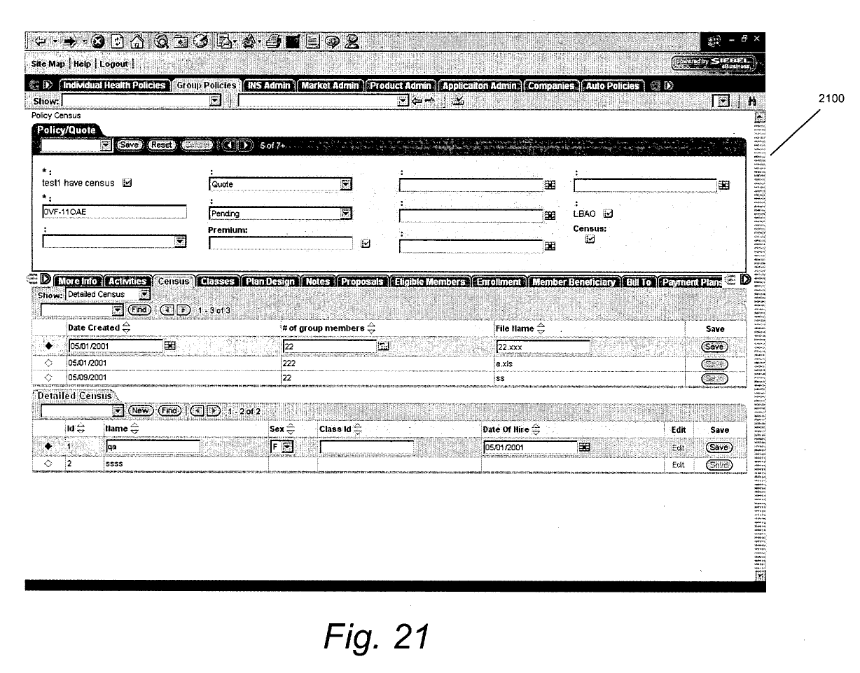

FIG. 21 is a diagram of an interface for associating detailed census records with a quotation or policy. Detailed information relates to individual member information. Interface 2100 allows detailed census records to be entered. In this particular example, fields are provided for individual detailed information related to “name,” “sex,” “classification ID,” and “date of hire.”

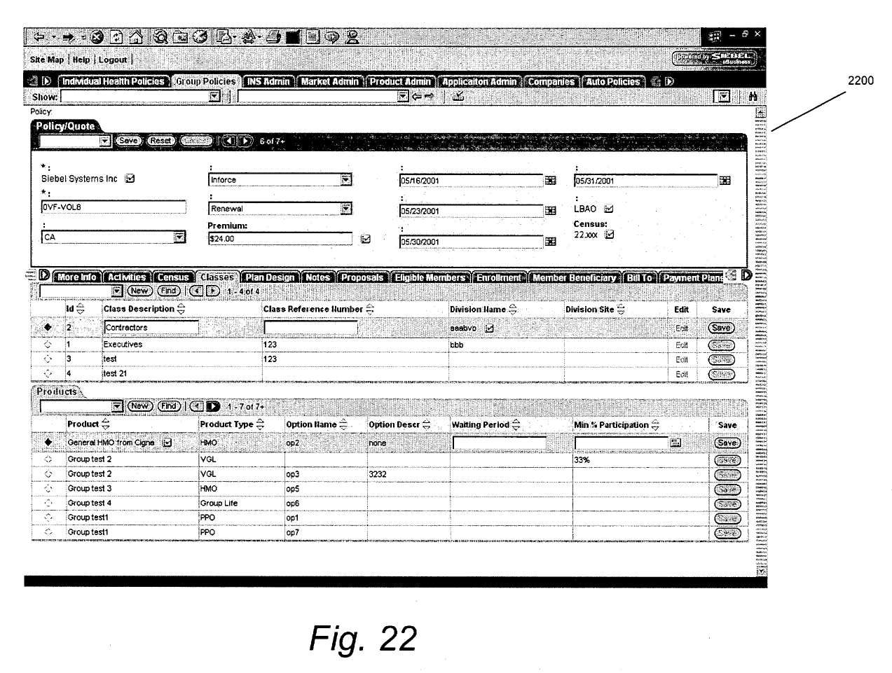

FIG. 22 is a diagram of an interface showing employee classes and product classes associated with each employee class for a given quotation or policy. Interface 2200 illustrates that a policy or plan can have multiple employee classes, and that product classes can have multiple products and product options. In this particular example a product is defined by attributes “product type,” “options,” and “options description.” Further information is provided for a waiting period for coverage and a minimum percentage of participation related to the particular product. Referring back to FIG. 16, group policy record information can be changed in step 1650 using interface 2200. Referring back to FIG. 17, policy information can be set, step 1715, using interface 2200.

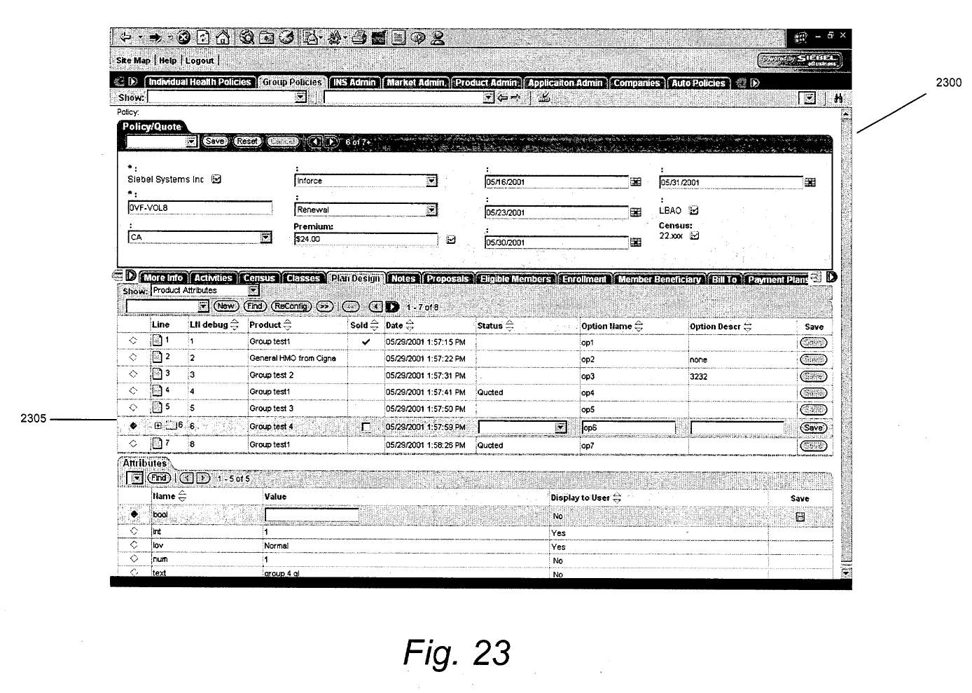

FIG. 23 is a diagram of an interface 2300 displaying a plan or quotation, including designating proposed products and attributes of the proposed products. Products can be “linked” to other products, such that the other products are automatically included as part of the “parent” product when the parent product is sold. For example, line item 2305 illustrates a parent product having children products (not shown, but indicated by the plus (+) sign).

One or more products can be associated with the plan or quote during a configuration session. Attributes such as a name, date, description, status (quoted, re-quoted, in force, or quote not accepted), indicator whether the product has been sold, bundled option, and product line can also be associated with the plan or quote.

In one embodiment, the configuration module allows configuration of Plan Details, Class Assignment, Rate History, Provider Networks, and other attributes for a plan or quote. An attribute can also be set indicating whether the plan or quote can be edited by a user.

In establishing a plan to fulfill a request for quotation, the user can enter requested features for employee benefits. In one embodiment, default provider networks are initially chosen and may be updated later. The user then associates all pertinent employee classes for given product offering. If customization is desired, the user can begin a configuration session to customize the plan design using an interface such as interfaces 1400A and 1400B of FIGS. 14A and 14B. Sets of products that can be sold together (“bundled options”) and attribute values that can be sold for a given product can be configured during the configuration session. The resulting plan design may include information related to data other than the product attributes, such as rate bands, deductible levels, and desired out of pocket premium payments.

A resulting plan design may have multiple versions of the same product presented as options to the group during the proposal/quoting stage. During enrollment, the class-product relationship is a one-to-one relationship. A sold attribute can be used to indicate the difference between quoted and sold products.

FIGS. 24 through 26 show interfaces for associating employee classes with products when configuring a group policy or quote. FIG. 24 is a diagram of an interface showing employee classes associated with a given policy in a particular policy or quotation. Employee classes can be added to a policy or quote, deleted, or modified using interface 2400. Products or services also can be associated with employee classes when members of the employee classes are eligible for such products or services. Interface 2400 also illustrates the option of associating employee classes with products. In this particular example, employee classes include “executives” and “contractors.”

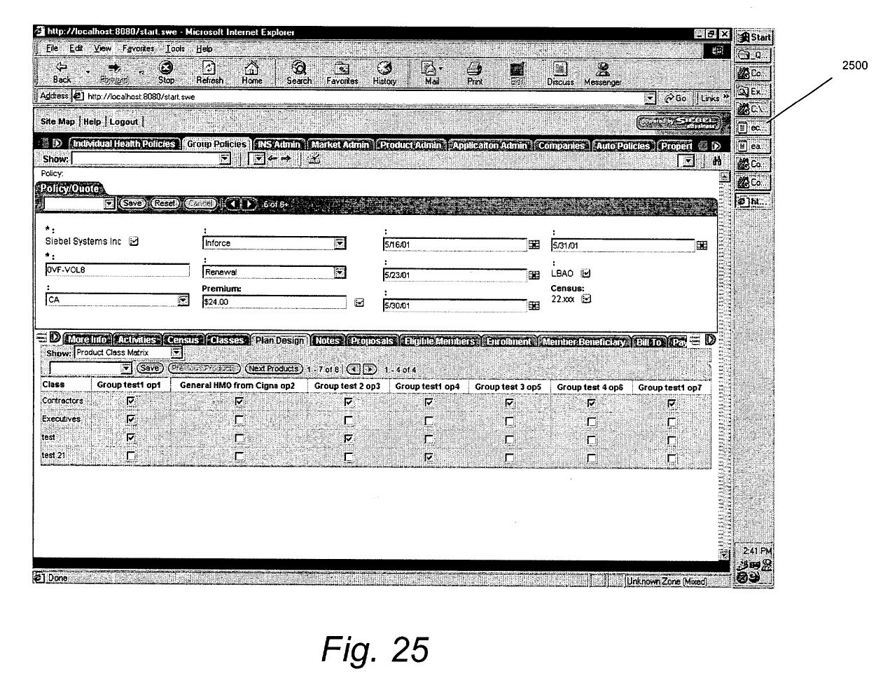

FIG. 25 is a diagram of an interface 2500 showing an alternative representation of employee class and product intersection from the representation shown in FIG. 24. A matrix showing relationships between products and employee classes is presented. A comparison between the various employee classes and various product offerings can be useful in designing a plan or quote.

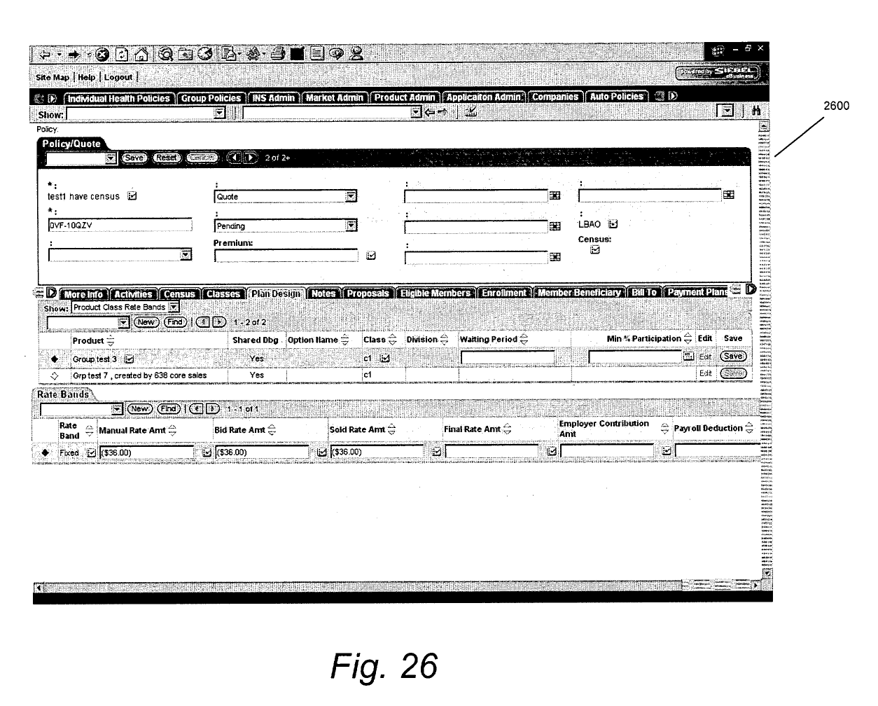

FIG. 26 is a diagram of an interface 2600 showing rates for product and employee class intersection. Different rates can be applicable to different product and employee class combinations. Interface 2600 illustrates a representation of the information to a user. The information presented is determined by rate bands related to the product and employee classes.

FIG. 27 is a diagram of an interface 2700 showing a quote proposed for a group policy. Using census and rate information, a salesperson can generate a quote proposal. Interface 2700 illustrates a representation of how a proposal can be recorded. Also shown in interface 2700 is an indication whether applicable census data have been received. Referring back to FIG. 16, step 1645 for generating proposals can be performed using interface 2700.

FIGS. 28 through 31 show interfaces for relating group policies to other data about a customer, such as activities, notes, service requests, and billing information. FIG. 28 is a diagram of an interface for adding eligible members. Once products and services are in place, eligible members can be entered through interface 2800. Member information can include relevant census information such as “social security number,” “name,” “date of birth” and “employee class.” Eligibility status can also be a field provided when entering members. Interface 2800 illustrates on-line enrollment of eligible members for policies. Referring back to FIG. 17, step 1700 for entering eligible members can be performed using interface 2800.

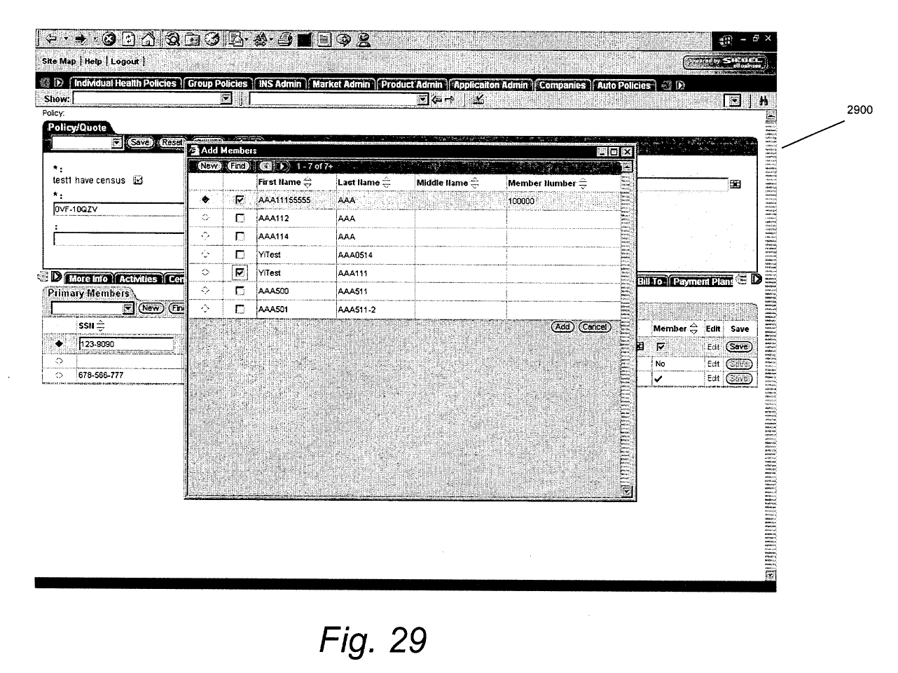

FIG. 29 is a diagram of an interface for adding eligible members using a network such as the Internet. Interface 2900 illustrates setting up member records prior to enrolling members on-line on the Internet or similar network. In this particular example, use of a web browser is illustrated. A tabular record of a list of members is provided and members to be entered are identified and submitted as a record via the Internet or other network. The appropriate managing database receives the tabular record and adds or updates member records. Referring back to FIG. 17, step 1700 for entering members can be performed using interface 2900.

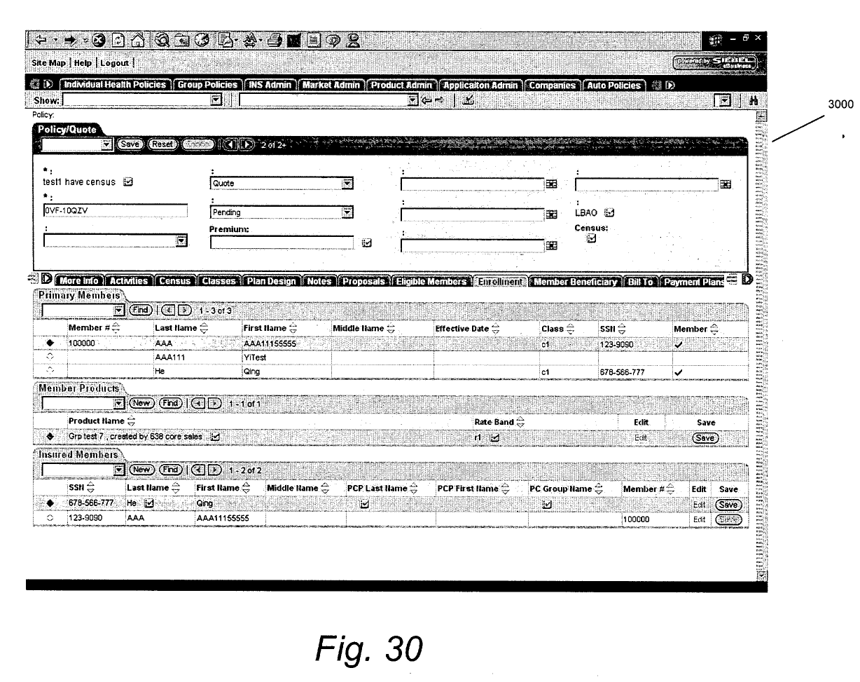

FIG. 30 is a diagram of an interface for directly enrolling eligible members for a group policy. A group of members can be enrolled directly as a group. Member records are associated with particular employee class records. Products for which the members are to be enrolled are identified and associated with each member. Interface 300 illustrates adding and deleting members from an enrollment list for a product directly.

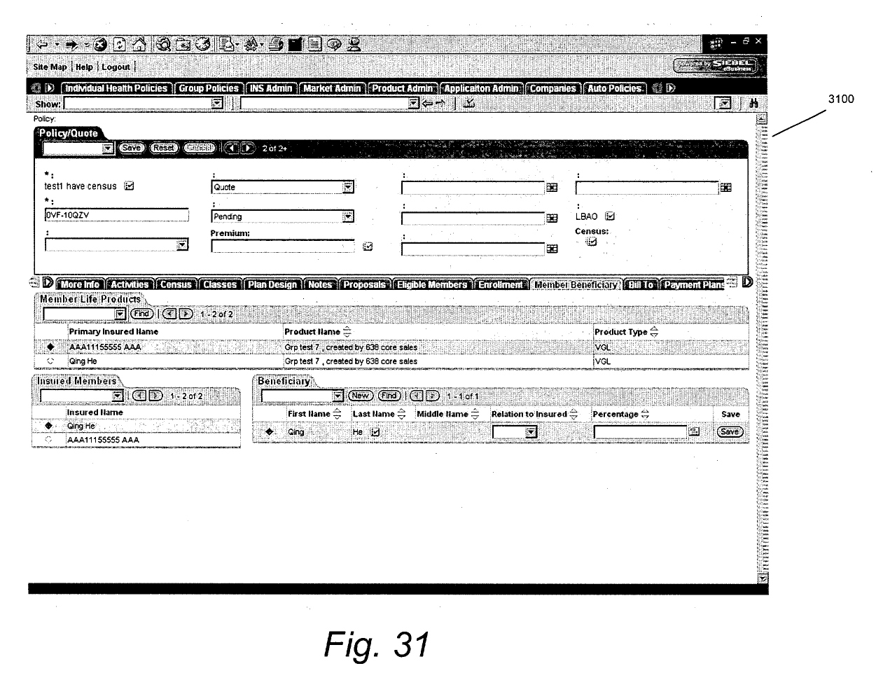

FIG. 31 is a diagram of an interface 3100 for adding dependents and beneficiaries for an enrolled member. Individual member records can include beneficiary information that can be added or modified as the situation of the member changes. Beneficiary records are directly associated with the insured member. The beneficiary record can include information such as relationship to the insured and the benefits available.

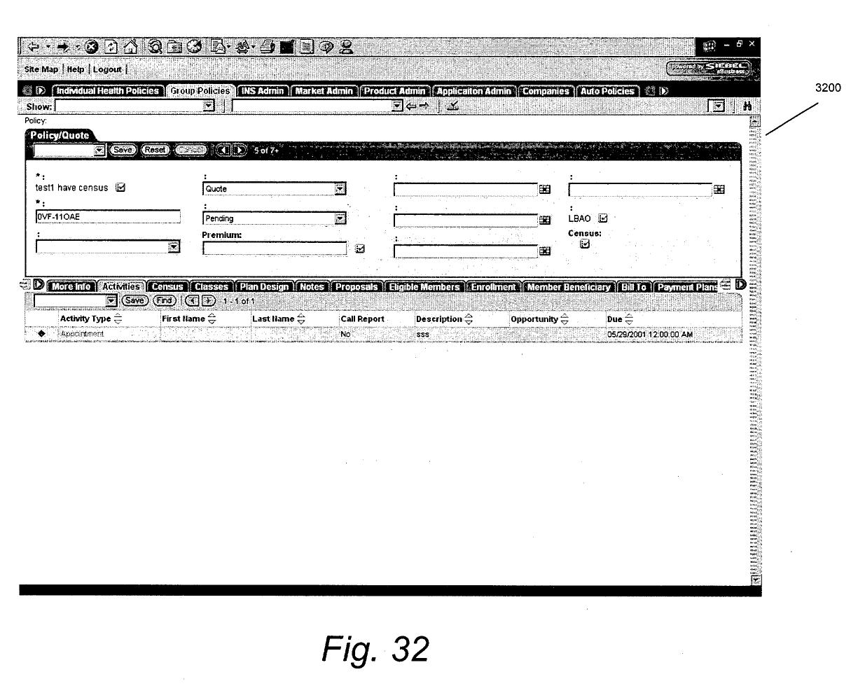

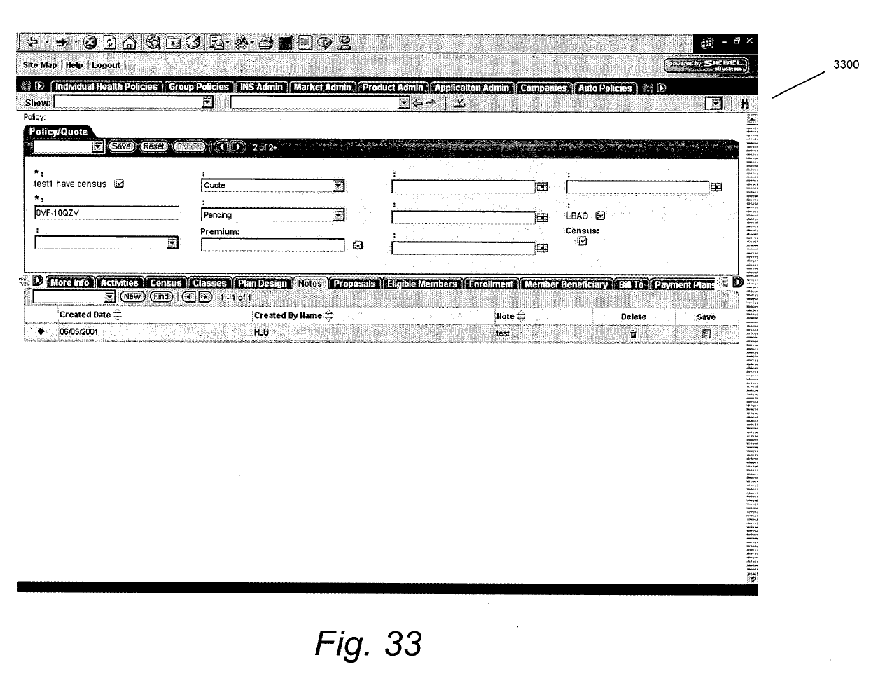

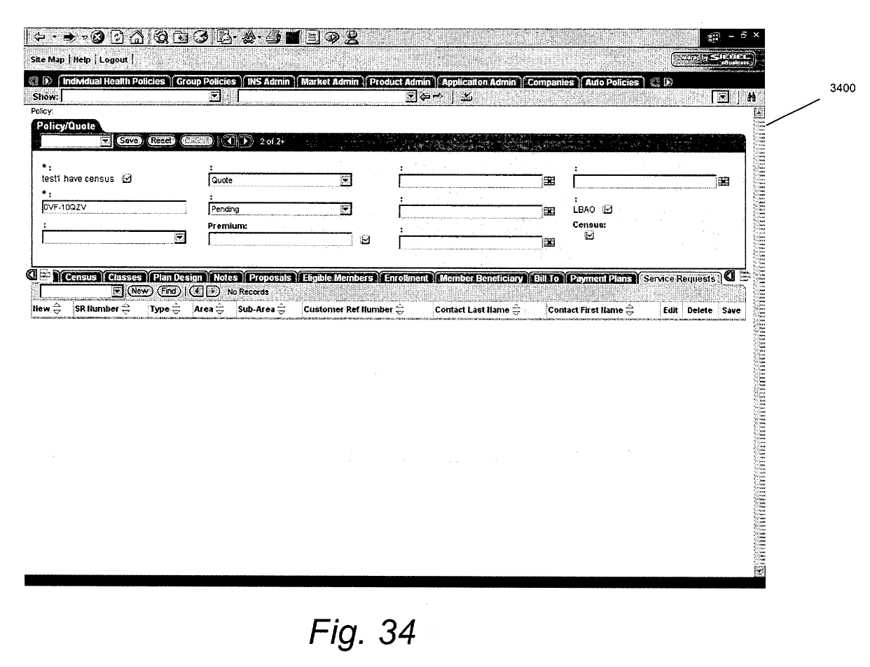

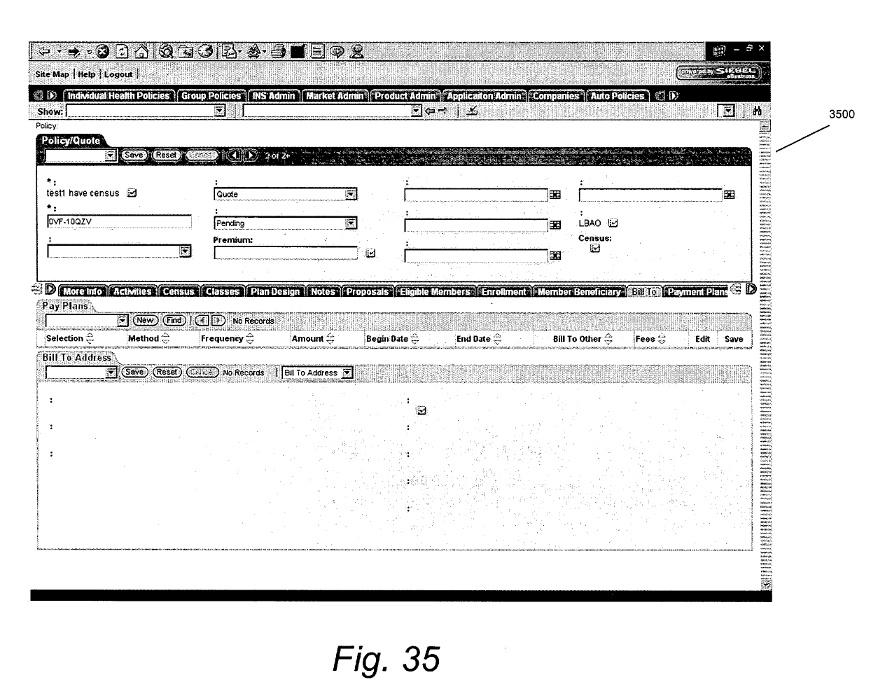

In the area of customer relationships management (CRM), extensive information is typically tracked for each customer. Associating such customer information with a group policy is desirable. To meet this need, in one embodiment, group policies can have CRM components that are either added as part of the group policy record or associated with the group policy record. FIG. 32 illustrates an interface relating group policies to components such as activities. Interface 3200 illustrates a group policy record with an activities CRM record for an appointment with the customer. FIG. 33 illustrates an interface relating group policies to components such as notes. Interface 3300 illustrates a group policy record with a notes CRM record for notes made about the group policy. FIG. 34 illustrates an interface relating group policies to components such as service requests. Interface 3400 illustrates a group policy record with a CRM record for a service request. FIG. 35 illustrates is an interface relating group policies to components such as billing information. Interface 3500 illustrates a group policy record with an associated billing information CRM record.

An Example Computing and Network Environment

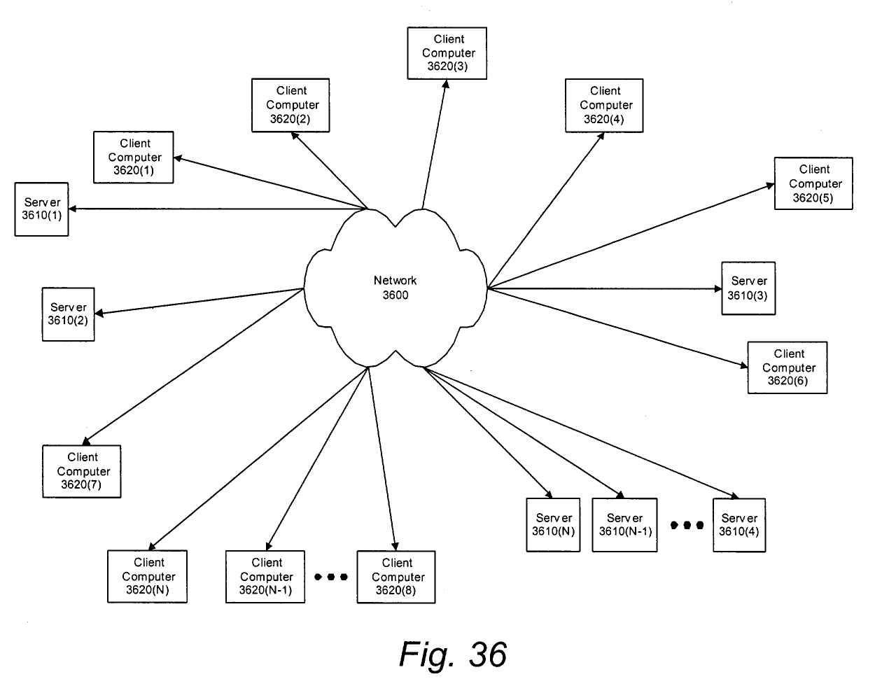

FIG. 36 is a block diagram illustrating a network environment in which a system according to the present invention may be practiced. As is illustrated in FIG. 36, network 3600, such as a private wide area network (WAN) or the Internet, includes a number of networked servers 3610(1)-(N) that are accessible by client computers 3620(1)-(N). Communication between client computers 3620(1)-(N) and servers 3610(1)-(N) typically occurs over a publicly accessible network, such as a public switched telephone network (PSTN), a DSL connection, a cable modem connection or large bandwidth trunks (e.g., communications channels providing T1 or OC3 service) or wireless link. Client computers 3620(1)-(N) access servers 3610(1)-(N) through, for example, a service provider. This might be, for example, an Internet Service Provider (ISP) such as America On-Line™, Prodigy™, CompuServe™ or the like. Access is typically had by executing application specific software (e.g., network connection software and a browser) on the given one of client computers 3620(1)-(N).

One or more of client computers 3620(1)-(N) and/or one or more of servers 3610(1)-(N) may be, for example, a computer system of any appropriate design, in general, including a mainframe, a mini-computer or a personal computer system. Such a computer system typically includes a system unit having a system processor and associated volatile and non-volatile memory, one or more display monitors and keyboards, one or more diskette drives, one or more fixed disk storage devices and one or more printers. These computer systems are typically information handling systems which are designed to provide computing power to one or more users, either locally or remotely. Such a computer system may also include one or a plurality of I/O devices (i.e., peripheral devices) which are coupled to the system processor and which perform specialized functions. Examples of I/O devices include modems, sound and video devices and specialized communication devices. Mass storage devices such as hard disks, CD-ROM drives and magneto-optical drives may also be provided, either as an integrated or peripheral device. One such example computer system, discussed in terms of client computers 3620(1)-(N) is shown in detail in FIG. 36.

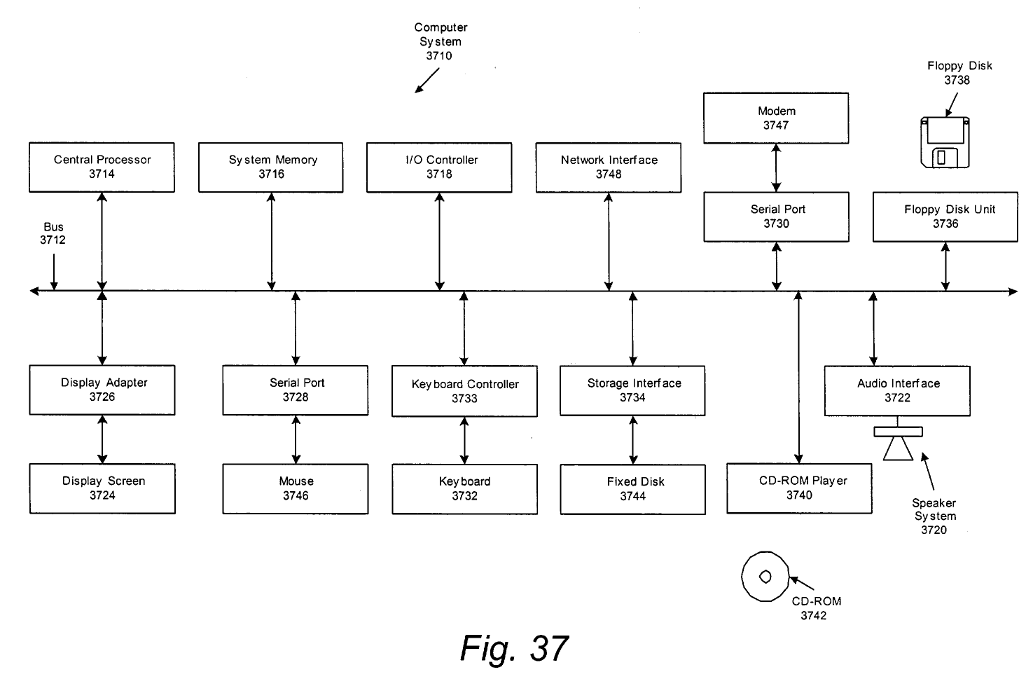

FIG. 37 depicts a block diagram of a computer system 3710 suitable for implementing the present invention, and example of one or more of client computers 3620(1)-(N). Computer system 3710 includes a bus 3712 which interconnects major subsystems of computer system 3710 such as a central processor 3714, a system memory 3716 (typically RAM, but which may also include ROM, flash RAM, or the like), an input/output controller 3718, an external audio device such as a speaker system 3720 via an audio output interface 3722, an external device such as a display screen 3724 via display adapter 3726, serial ports 3728 and 3730, a keyboard 3732 (interfaced with a keyboard controller 3733), a storage interface 3734, a floppy disk drive 3736 operative to receive a floppy disk 3738, and a CD-ROM drive 3740 operative to receive a CD-ROM 3742. Also included are a mouse 3746 (or other point-and-click device, coupled to bus 3712 via serial port 3728), a modem 3747 (coupled to bus 3712 via serial port 3730) and a network interface 3748 (coupled directly to bus 3712).

Bus 3712 allows data communication between central processor 3714 and system memory 3716, which may include both read only memory (ROM) or flash memory (neither shown), and random access memory (RAM) (not shown), as previously noted. The RAM is generally the main memory into which the operating system and application programs are loaded and typically affords at least 66 megabytes of memory space. The ROM or flash memory may contain, among other code, the Basic Input-Output system (BIOS) which controls basic hardware operation such as the interaction with peripheral components. Applications resident with computer system 3710 are generally stored on and accessed via a computer readable medium, such as a hard disk drive (e.g., fixed disk 3744), an optical drive (e.g., CD-ROM drive 3740), floppy disk unit 3736 or other storage medium. Additionally, applications may be in the form of electronic signals modulated in accordance with the application and data communication technology when accessed via network modem 3747 or interface 3748.

Storage interface 3734, as with the other storage interfaces of computer system 3710, may connect to a standard computer readable medium for storage and/or retrieval of information, such as a fixed disk drive 3744. Fixed disk drive 3744 may be a part of computer system 3710 or may be separate and accessed through other interface systems. Many other devices can be connected such as a mouse 3746 connected to bus 3712 via serial port 3728, a modem 3747 connected to bus 3712 via serial port 3730 and a network interface 3748 connected directly to bus 3712. Modem 3747 may provide a direct connection to a remote server via a telephone link or to the Internet via an internet service provider (ISP). Network interface 3748 may provide a direct connection to a remote server via a direct network link to the Internet via a POP (point of presence). Network interface 3748 may provide such connection using wireless techniques, including digital cellular telephone connection, general packet radio service (GPRS) connection, digital satellite data connection or the like.

Many other devices or subsystems (not shown) may be connected in a similar manner (e.g., bar code readers, document scanners, digital cameras and so on). Conversely, it is not necessary for all of the devices shown in FIG. 37 to be present to practice the present invention. The devices and subsystems may be interconnected in different ways from that shown in FIG. 37. The operation of a computer system such as that shown in FIG. 37 is readily known in the art and is not discussed in detail in this application. Code to implement the present invention may be stored in computer-readable storage media such as one or more of system memory 3716, fixed disk 3744, CD-ROM 3742, or floppy disk 3738. Additionally, computer system 3710 may be any kind of computing device, and so includes personal data assistants (PDAs), network appliance, X-window terminal or other such computing device. Computer system 3710 also supports a number of Internet access tools, including, for example, an HTTP-compliant web browser having a JavaScript interpreter.

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to-the first signal, whether due to circuit limitations or due to passage through other circuit elements which do not change the informational and/or final functional aspect of the first signal.

The foregoing described embodiment wherein the different components are contained within different other components (e.g., the various elements shown as components of computer system 3710). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “closely connected,” or “closely coupled,” to each other to achieve the desired functionality.

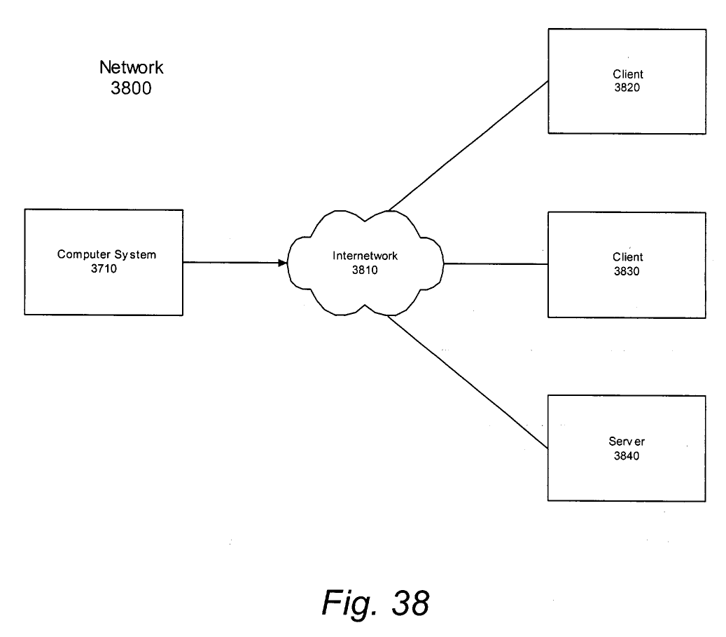

FIG. 38 is a block diagram depicting a network 3800 in which computer system 3710 is coupled to an internetwork 3810, which is coupled, in turn, to client systems 3820 and 3830, as well as a server 3840. Internetwork 3810 (e.g., the Internet) is also capable of coupling client systems 3820 and 3830, and server 3840 to one another. With reference to computer system 3810, modem 3847, network interface 3848 or some other method can be used to provide connectivity from computer system 3810 to internetwork 3810. Computer system 3810, client system 3820 and client system 3830 are able to access information on server 3840 using, for example, a web browser (not shown). Such a web browser allows computer system 3810, as well as client systems 3820 and 3830, to access data on server 3840 representing the pages of a website hosted on server 3840. Protocols for exchanging data via the Internet are well known to those skilled in the art. Although FIG. 38 depicts the use of the Internet for exchanging data, the present invention is not limited to the Internet or any particular network-based environment.

Referring to FIGS. 36, 37 and 38, a browser running on computer system 3810 employs a TCP/IP connection to pass a request to server 3840, which can run an HTTP “service” (e.g., under the WINDOWS® operating system) or a “daemon” (e.g., under the UNIX® operating system), for example. Such a request can be processed, for example, by contacting an HTTP server employing a protocol that can be used to communicate between the HTTP server and the client computer. The HTTP server then responds to the protocol, typically by sending a “web page” formatted as an HTML file. The browser interprets the HTML file and may form a visual representation of the same using local resources (e.g., fonts and colors).

Although the present invention has been described in connection with several embodiments, the invention is not intended to be limited to the specific forms set forth herein, but on the contrary, it is intended to cover such alternatives, modifications, and equivalents as can be reasonably included within the scope of the invention as defined by the appended claims.

What is claimed is:

1. A method comprising:
creating a quote for providing a benefit; and
automatically determining a set of products that can be associated with the quote, wherein each product in the set of products satisfies a rule for associating the product with the quote.

2. The method of claim 1 further comprising:
associating a product from the set of products with the quote.

3. The method of claim 2 further comprising:
automatically associating a second product with the quote when the rule requires the second product to be included with the product.

4. The method of claim 2 further comprising:
automatically setting an attribute of the product to a required value when the rule indicates the required value for the attribute.

5. The method of claim 2 further comprising:
automatically setting an attribute of a second product associated with the quote to a required value when
the product has a given attribute value, and
the rule indicates a relationship between the required value for the attribute of the second product and the given attribute value for the product.

6. The method of claim 2 further comprising:
associating census information for a set of employees with the quote; and
obtaining a rate for the product using the census information for the set of employees,
wherein
the product is automatically priced at the rate in the quote.

7. The method of claim 6 further comprising:
automatically obtaining a second rate for a second product using the census information for the set of employees when the rule requires the second product to be included with the product, wherein
the second product is automatically priced in the quote at the second rate.

8. The method of claim 2 further comprising:
establishing a rule for associating the product with quote.

9. The method of claim 2 further comprising:
proposing the quote; and
converting the quote to the benefit when the quote is accepted.

10. The method of claim 9 further comprising:
enrolling an employee to receive the benefit.

11. A system comprising:
creating means for creating a quote for providing a benefit; and
determining means for automatically determining a set of products that can be associated with the quote, wherein
each product in the set of products satisfies a rule for associating the product with the quote.

12. The system of claim 11 further comprising:
associating means for associating a product from the set of products with the quote.

13. The system of claim 12 further comprising:
second associating means for automatically associating a second product with the quote when the rule requires the second product to be included with the product.

14. The system of claim 12 further comprising:
attribute-setting means for automatically setting an attribute of the product to a required value when the rule indicates the required value for the attribute.

15. The system of claim 12 further comprising:
attribute-setting means for automatically setting an attribute of a second product associated with the quote to a required value when
the product has a given attribute value, and
the rule indicates a relationship between the required value for the attribute of the second product and the given attribute value for the product.

16. The system of claim 12 further comprising:
census associating means for associating census information for a set of employees with the quote; and
rate obtaining means for obtaining a rate for the product using the census information for the set of employees, wherein
the product is automatically priced at the rate in the quote.

17. The system of claim 16 further comprising:
second rate obtaining means for automatically obtaining a second rate for a second product using the census information for the set of employees when the rule requires the second product to be included with the product, wherein
the second product is automatically priced in the quote at the second rate.

18. The system of claim 12 further comprising:
rule establishing means for establishing a rule for associating the product with quote.

19. A system comprising:
a creating module to creating a quote for providing a benefit; and
a determining module to automatically determining a set of products that can be associated with the quote, wherein
each product in the set of products satisfies a rule for associating the product with the quote.

20. The system of claim 19 further comprising:
an associating module to associate a product from the set of products with the quote.

21. The system of claim 20 further comprising:
a second associating module to automatically associate a second product with the quote when the rule requires the second product to be included with the product.

22. The system of claim 20 further comprising:
an attribute-setting module to automatically set an attribute of the product to a required value when the rule indicates the required value for the attribute.

23. The system of claim 20 further comprising:
an attribute-setting module to automatically set an attribute of a second product associated with the quote to a required value when
the product has a given attribute value, and
the rule indicates a relationship between the required value for the attribute of the second product and the given attribute value for the product.

24. The system of claim 20 further comprising:
a census associating module to associate census information for a set of employees with the quote; and
a rate obtaining module to obtain a rate for the product using the census information for the set of employees, wherein
the product is automatically priced at the rate in the quote.

25. The system of claim 24 further comprising:
a second rate obtaining module to automatically obtain a second rate for a second product using the census information for the set of employees when the rule requires the second product to be included with the product, wherein
the second product is automatically priced in the quote at the second rate.

26. The system of claim 20 further comprising:
a rule establishing module to establish a rule for associating the product with quote.

27. A computer program product comprising:
creating instructions to create a quote for providing a benefit;
determining instructions to automatically determining a set of products that can be associated with the quote, wherein
each product in the set of products satisfies a rule for associating the product with the quote; and
a computer-readable medium to store the creating instructions and the determining instructions.

28. The computer program product of claim 27 further comprising:
associating instructions to associate a product from the set of products with the quote,
wherein
the computer-readable medium further stores the associating instructions.

29. The computer program product of claim 28 further comprising:
second associating instructions to automatically associate a second product with the quote when the rule requires the second product to be included with the product, wherein
the computer-readable medium further stores the second associating instructions.

30. The computer program product of claim 28 further comprising:
attribute-setting instructions to automatically set an attribute of the product to a required value when the rule indicates the required value for the attribute wherein
the computer-readable medium further stores the attribute-setting instructions.

31. The computer program product of claim 28 further comprising:
attribute-setting instructions to automatically set an attribute of a second product associated with the quote to a required value when
the product has a given attribute value, and
the rule indicates a relationship between the required value for the attribute of the second product and the given attribute value for the product, wherein the computer-readable medium further stores the attribute-setting instructions.

32. The computer program product of claim 28 further comprising:
census associating instructions to associate census information for a set of employees with the quote; and
rate obtaining instructions to obtain a rate for the product using the census information for the set of employees, wherein
the product is automatically priced at the rate in the quote, and
the computer-readable medium further stores the census associating instructions and the rate obtaining instructions.

33. The computer program product of claim 32 further comprising:
second rate obtaining instructions to automatically obtain a second rate for a second product using the census information for the set of employees when the rule requires the second product to be included with the product, wherein
the second product is automatically priced in the quote at the second rate, and the computer-readable medium further stores the second rate obtaining instructions.

34. The computer program product of claim 28 further comprising:
rule establishing instructions to establish a rule for associating the product with quote, wherein
the computer readable medium further stores the rule establishing instructions.
